(19) United States
(12) Patent Application Publication
(10) Pub. No.: US 2013/0112096 A1
(43) Pub. Date: May 9, 2013

(54) RESIN COMPOSITION FOR LASER ENGRAVING, RELIEF PRINTING PLATE PRECURSOR FOR LASER ENGRAVING AND PROCESS FOR PRODUCING SAME, AND RELIEF PRINTING PLATE AND PROCESS FOR MAKING SAME

(71) Applicant: FUJIFILM Corporation, Tokyo (JP)

(72) Inventor: Katsuhiro YAMASHITA, Haibara-gun (JP)

(73) Assignee: FUJIFILM Corporation, Tokyo (JP)

(21) Appl. No.: 13/730,122

(22) Filed: Dec. 28, 2012

Related U.S. Application Data
(63) Continuation of application No. PCT/JP2011/063264, filed on Jun. 9, 2011.

(30) Foreign Application Priority Data
Jun. 29, 2010 (JP) 2010-147667

(51) Int. Cl. C08L 37/00

(52) U.S. Cl. 101/395; 525/55; 525/342; 525/384; 427/508; 427/385.5; 427/555

(57) ABSTRACT

To provide a resin composition for laser engraving that can give a film having excellent compositional uniformity and toughness and a relief printing plate having little breakage of small-size halftone dots, a relief printing plate precursor employing the resin composition for laser engraving, a process for making a relief printing plate employing same, and a relief printing plate obtained thereby.

A resin composition for laser engraving of the present invention that includes (Component A) a compound having one or more condensable groups and having one or more radical chain transfer groups; (Component B) a radically polymerizable compound; (Component C) a radical polymerization initiator; and (Component D) a binder polymer.

### TECHNICAL FIELD

The present invention relates to a resin composition for laser engraving, a relief printing plate precursor for laser engraving and a process for producing the same, and a relief printing plate and a process for making the same.

### BACKGROUND ART

A large number of so-called “direct engraving CTP methods”, in which a relief-forming layer is directly engraved by means of a laser are proposed. In the method, a laser light is directly irradiated to a flexographic printing plate precursor to cause thermal decomposition and volatilization by photothermal conversion, thereby forming a concave part. Differing from a relief formation using an original image film, the direct engraving CTP method can control freely relief shapes. Consequently, when such image as an outline character is to be formed, it is also possible to engrave that region deeper than other regions, or, in the case of a fine halftone dot image, it is possible, taking into consideration resistance to printing pressure, to engrave while adding a shoulder. With regard to the laser for use in the method, a high-power carbon dioxide laser is generally used. In the case of the carbon dioxide laser, all organic compounds can absorb the irradiation energy and convert it into heat. On the other hand, inexpensive and small-sized semiconductor lasers have been developed, wherein, since they emit visible lights and near infrared lights, it is necessary to absorb the laser light and convert it into heat.

Since the raised part of a relief in a laser engraving type relief printing plate (flexographic plate) has the same physical properties as those of the relief printing plate precursor (flexographic plate precursor), it is necessary for the flexographic plate precursor itself to have the flexibility, hardness, chemical resistance, etc. necessary for printing. The flexographic plate precursor is given desired physical properties by thermal curing or photocuring, but it is difficult to produce, by photocuring, a flexographic plate precursor that can carry out photothermal conversion of visible and near-infrared light lasers, and as a solution for this a method for producing a laser engraving type flexographic plate precursor by thermal crosslinking has been disclosed (JP-A-2008-63553 (JP-A denotes a Japanese unexamined patent application publication)).

Furthermore, as a relief printing plate precursor for laser engraving, those described in EP No. 1936438 A1 and JP-A-2009-262370 are known.

Thermal curing or photocuring of a relief-forming layer of the relief printing plate precursor utilizes a crosslinking reaction or a chain transfer polymerization reaction of a binder, but it has become clear that desired film physical properties such as film toughness cannot be obtained due to phase separation of a polymer formed in the film.

It is an object of the present invention to provide a resin composition for laser engraving that can give a film having excellent compositional uniformity and toughness and a relief printing plate having little breakage of small-size halftone dots, a relief printing plate precursor employing the resin composition for laser engraving, a process for making a relief printing plate employing same, and a relief printing plate obtained thereby.

### MEANS FOR SOLVING THE PROBLEMS

The above-mentioned objects of the present invention have been attained by means <1>, <8> to <11>, and <13> below. They are listed together with <2> to <7>, <12>, <14>, and <15>, which are preferred embodiments.

<1> A resin composition for laser engraving, comprising (Component A) a compound having one or more condensable groups and having one or more radical chain transfer groups, (Component B) a radically polymerizable compound, (Component C) a radical polymerization initiator, and (Component D) a binder polymer,
<2> the resin composition for laser engraving according to <1> above, wherein Component D has a group that can react with the condensable group,
<3> the resin composition for laser engraving according to <1> or <2> above, wherein the condensable group is a hydrolyzable silyl group and/or silanol group,
<4> the resin composition for laser engraving according to any one of <1> to <3> above, wherein the radical chain transfer group is a thiol group or a disulfide group,
<5> the resin composition for laser engraving according to any one of <1> to <4> above, wherein the resin composition further comprises (Component E) a compound having two or more hydrolyzable silyl groups and/or silanol groups,
<6> the resin composition for laser engraving according to any one of <1> to <5> above, wherein the resin composition further comprises (Component F) a condensation reaction catalyst,
<7> the resin composition for laser engraving according to any one of <1> to <6> above, wherein Component B comprises a compound having two or more (meth)acrylic groups,
<8> a relief printing plate precursor for laser engraving having a relief-forming layer comprising the resin composition for laser engraving according to any one of <1> to <7> above,
<9> a relief printing plate precursor for laser engraving having a crosslinked relief-forming layer formed by crosslinking by means of light and/or heat a relief-forming layer comprising the resin composition for laser engraving according to any one of <1> to <7> above,
<10> a process for producing a relief printing plate precursor for laser engraving, comprising a layer formation step of forming a relief-forming layer comprising the resin composition for laser engraving according to any one of <1> to <7> above, and a crosslinking step of crosslinking the relief-forming layer by means of light and/or heat to thus obtain a relief printing plate precursor having a crosslinked relief-forming layer,
<11> a process for making a relief printing plate, comprising a layer formation step of forming a relief-forming layer comprising the resin composition for laser engraving according to any one of <1> to <7> above, a crosslinking step of thermally crosslinking the relief-forming layer to thus obtain a relief printing plate precursor having a crosslinked relief-forming layer, and an engraving step of laser-engraving the relief printing plate precursor having a crosslinked relief-forming layer to thus form a relief layer,
<12> the process for making a relief printing plate according to <11> above, wherein it further comprises a rinsing step of rising the relief layer surface after engraving with an aqueous rinsing liquid,
<13> a relief printing plate having a relief layer made by the process for making a relief printing plate according to <11> or <12> above,
<14> the relief printing plate according to <13> above, wherein the relief layer has a thickness of at least 0.05 mm but no greater than 10 mm, and
<15> the relief printing plate according to <13> or <14> above, wherein the relief layer has a Shore A hardness of at least 50° but no greater than 90°.

### MODE FOR CARRYING OUT THE PRESENT INVENTION

The present invention is explained in detail below.

In the present invention, the notation ‘lower limit to upper limit’, which expresses a numerical range, means ‘at least the lower limit but no greater than the upper limit’, and the notation ‘upper limit to lower limit’ means ‘no greater than the upper limit but at least the lower limit’. That is, they are numerical ranges that include the upper limit and the lower limit.

Furthermore, ‘(Component A) a compound having one or more condensable groups and having one or more radical chain transfer groups’ etc. are simply called ‘Component A’ etc.

### (Resin Composition for Laser Engraving)

The resin composition for laser engraving (hereinafter, also called simply a ‘resin composition’) of the present invention comprises (Component A) a compound having one or more condensable groups and having one or more radical chain transfer groups, (Component B) a radically polymerizable compound, (Component C) a radical polymerization initiator, and (Component D) a binder polymer.

The resin composition for laser engraving of the present invention may be applied to a wide range of uses where it is subjected to laser engraving, other than use as a relief-forming layer of a relief printing plate precursor, without particular limitations. For example, it may be applied not only to a relief-forming layer of a printing plate precursor where formation of a raised relief is carried out by laser engraving, which is explained in detail below, but also to the formation of various types of printing plates or various types of moldings in which image formation is carried out by laser engraving, such as another material form having asperities or openings formed on the surface such as for example an intaglio printing plate, a stencil printing plate, or a stamp.

Among them, the application thereof to the formation of a relief-forming layer provided on an appropriate support is a preferred embodiment.

In the present specification, with respect to explanation of the relief printing plate precursor, a non-crosslinked crosslinkable layer comprising (Component D) a binder polymer such as a polymer that the number-average molecular weight is 500 to 5,000,000 and having a flat surface as an image formation layer that is subjected to laser engraving is called a relief-forming layer, a layer that is formed by crosslinking the relief-forming layer is called a crosslinked relief-forming layer, and a layer that is formed by subjecting this to laser engraving so as to form asperities on the surface is called a relief layer.

Constituent components of the resin composition for laser engraving are explained below.

### <(Component A) Compound Having One or More Condensable Groups and Having One or More Radical Chain Transfer Groups>

The resin composition for laser engraving of the present invention comprises (Component A) a compound having one or more condensable groups and having one or more radical chain transfer groups.

Due to the resin composition for laser engraving of the present invention comprising Component A, phase separation of a polymer formed in a film is suppressed, and a film having excellent compositional uniformity and toughness and a relief printing plate having little breakage of small-size halftone dots can be obtained.

The condensable group referred to here is a functional group that can form a bond by a condensation reaction.

The condensation reaction referred to here is a reaction in which parts are separated from two functional groups, and they bond together to form a small molecule and leave. At the same time, remaining parts of the two functional groups bond together to form a new functional group. Examples thereof include a dehydration reaction between two carboxylic acid groups, a dehydration reaction between a carboxylic acid and an alcohol, a dehydration reaction between two alcohols, a dealcoholization reaction between two alkoxysilyl groups, and a condensation reaction between a hydrolyzable silyl group or a silanol group and a hydroxy group.

Examples of the condensable group in Component A include a hydrolyzable silyl group, a silanol group, a carboxyl group, and a hydroxy group. Among them, a hydrolyzable silyl group and a silanol group are particularly preferable.

With regard to the condensable group, Component A may have only one type or two or more types.

The number of condensable groups in Component A is at least 1, more preferably 1 to 6, yet more preferably 1 or 2, and particularly preferably 1.

The hydrolyzable silyl group is a silyl group that can be hydrolyzed, and examples of the hydrolyzable group bonded to a silicon atom include an alkoxy group, a mercapto group, a halogen atom, an amide group, an acetoxy group, an amino group, and an isopropenoxy group.

Furthermore, a silyl group undergoes hydrolysis to become a silanol group, and a silanol group undergoes dehydration-condensation to form a siloxane bond.

Such a hydrolyzable silyl group or silanol group is preferably a group represented by Formula (1) below.

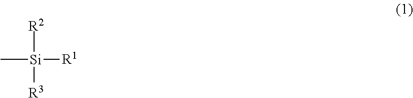

In Formula (1) above, at least one of R¹ to R³ denotes a hydrolyzable group selected from the group consisting of an alkoxy group, a mercapto group, a halogen atom, an amide group, an acetoxy group, an amino group, and an isopropenoxy group, or a hydroxy group. The remainder of R¹ to R³ independently denote a hydrogen atom, a halogen atom, or a monovalent organic substituent (examples including an alkyl group, an aryl group, an alkenyl group, an alkynyl group, and an aralkyl group).

In Formula (1) above, the hydrolyzable group bonded to the silicon atom is particularly preferably an alkoxy group or a halogen atom, and more preferably an alkoxy group.

From the viewpoint of rinsing properties and printing durability, the alkoxy group is preferably an alkoxy group having 1 to 30 carbon atoms, more preferably an alkoxy group having 1 to 15 carbon atoms, yet more preferably an alkoxy group having 1 to 5 carbon atoms, particularly preferably an alkoxy group having 1 to 3 carbon atoms, and most preferably a methoxy group or an ethoxy group.

Furthermore, examples of the halogen atom include an F atom, a Cl atom, a Br atom, and an I atom, and from the viewpoint of ease of synthesis and stability it is preferably a Cl atom or a Br atom, and more preferably a Cl atom.

A range of 1 to 4 of the hydrolyzable groups may bond to one silicon atom, and the total number of hydrolyzable groups in Formula (1) is preferably in a range of 2 or 3. It is particularly preferable that three hydrolyzable groups are bonded to a silicon atom. When two or more hydrolyzable groups are bonded to a silicon atom, they may be identical to or different from each other.

Specific preferred examples of the alkoxy group include a methoxy group, an ethoxy group, a propoxy group, an isopropoxy group, a butoxy group, a tert-butoxy group, a phenoxy group, and a benzyloxy group. A plurality of each of these alkoxy groups may be used in combination, or a plurality of different alkoxy groups may be used in combination.

Examples of the alkoxysilyl group having an alkoxy group bonded thereto include a trialkoxysilyl group such as a trimethoxysilyl group, a triethoxysilyl group, a triisopropoxysilyl group, or a triphenoxysilyl group; a dialkoxymonoalkylsilyl group such as a dimethoxymethylsilyl group or a diethoxymethylsilyl group; and a monoalkoxydialkylsilyl group such as a methoxydimethylsilyl group or an ethoxydimethylsilyl group.

The chain transfer group referred to here is a functional group that receives a radical from a polymer chain growing in a chain transfer polymerization reaction and stops extension of the polymer, and the chain transfer agent that has received a radical can start polymerization again by attacking a monomer. Examples include a thiol group, a disulfide group, a phenol group, and an allyl group.

The chain transfer group in Component A is preferably a thiol group, a disulfide group, or an allyl group, more preferably a thiol group or a disulfide group, and particularly preferably a thiol group.

With regard to the chain transfer group, Component A may have one type thereof or two or more types thereof.

The number of chain transfer groups in Component A is at least one, more preferably 1 to 6, yet more preferably 1 or 2, and particularly preferably 1.

Component A is preferably a compound represented by Formulae (A1) to (A4) below.

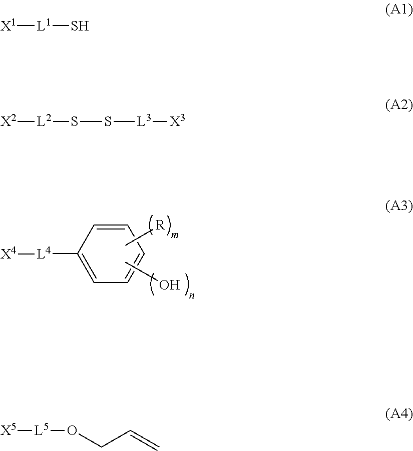

(In Formula (A1) to Formula (A4), L¹ to L⁵ independently denote a divalent linking group, X¹ to X⁵ independently denote a condensable group, m denotes an integer of 0 to 4, n denotes an integer of 1 to 5, and R denotes a monovalent substituent.)

The divalent linking group denoted by L¹ to L⁵ is preferably a divalent group comprising carbon and hydrogen atoms or a divalent group comprising carbon, hydrogen, and oxygen atoms, and more preferably a divalent group comprising carbon and hydrogen atoms.

As the divalent group comprising carbon and hydrogen atoms, a divalent aliphatic hydrocarbon group, a divalent aromatic hydrocarbon group, and a group formed by combining them can preferably be cited, a straight-chain or branched alkylene group can more preferably be cited, and a straight-chain alkylene group can yet more preferably be cited.

Furthermore, the number of carbon atoms of L¹ to L⁵ is preferably 1 to 20, more preferably 3 to 8, yet more preferably 3 to 5, and particularly preferably 3.

The condensable group denoted by X¹ to X⁵ is preferably a hydrolyzable silyl group, a silanol group, a carboxyl group, or a hydroxy group, and more preferably a hydrolyzable silyl group or a silanol group. The hydrolyzable silyl group or silanol group is preferably a group represented by Formula (1) above.

Furthermore, n is preferably 1 or 2, and more preferably 1.

Moreover, m is preferably 0 to 2, more preferably 0 or 1, and yet more preferably 0.

Examples of the monovalent substituent denoted by R include an alkyl group, an aryl group (preferably 6 to 20 carbons, and more preferably 6 to 10 carbons), an alkoxy group, an aryloxy group, and a halogen atom.

Furthermore, the substitution position of a hydroxy group on the benzene ring in Formula (A3) is not particularly limited, but it is preferably the para position with respect to L⁴.

Specific preferred examples of Component A include A-1 to A-6 shown below, but needless to say Component A is not limited thereby. In the chemical formulae below, Et denotes an ethyl group and Me denotes a methyl group.

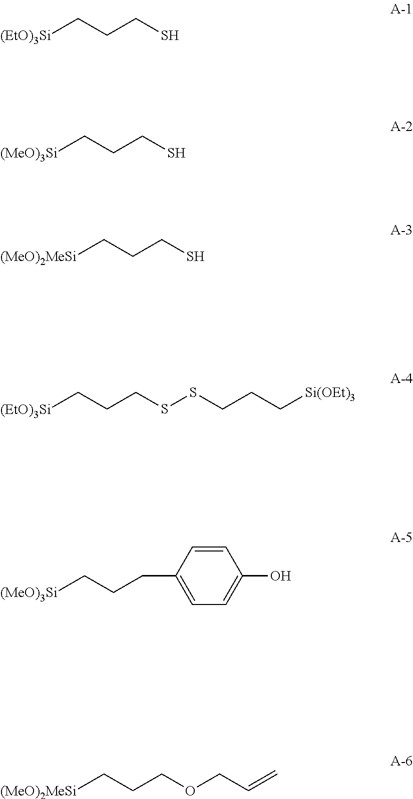

With regard to Component A in the resin composition of the present invention, one type may be used on its own or two or more types may be used in combination.

The amount of Component A contained in the resin composition of the present invention is preferably 0.2 to 25 wt % relative to the total solids content, more preferably 1 to 10 wt %, and particularly preferably 1.5 to 5 wt %.

### <(Component B) Radically Polymerizable Compound>

In the present invention, from the viewpoint of forming a crosslinked structure in the relief-forming layer, in order to form this, a coating solution for the relief-forming layer (the resin composition of the present invention) preferably comprises (Component B) a radically polymerizable compound.

The radically polymerizable compound that can be used in the present invention may be freely selected from compounds having at least one ethylenically unsaturated bond, preferably at least two, and more preferably two to six.

Furthermore, the radically polymerizable compound that can be used in the present invention is preferably a compound having two or more (meth)acrylic groups, and more preferably a compound having two or more (meth)acryloxy groups.

Hereinafter, monofunctional monomers having one ethylenically unsaturated group, and polyfunctional monomers having two or more ethylenically unsaturated groups, used as a radically polymerizable compound, are explained.

In the resin composition of the present invention, polyfunctional monomers are preferably used in order to form a crosslinked structure in the film. The polyfunctional ethylenically unsaturated compound has preferably a molecular weight of 200 to 2,000.

Examples of the monofunctional monomers include esters of an unsaturated carboxylic acid (such as acrylic acid, methacrylic acid, itaconic acid, crotonic acid, isocrotonic acid or maleic acid) with a monovalent alcohol compound, amides of an unsaturated carboxylic acid with a monovalent amine compound, etc. Examples of the polyfunctional monomers include esters of an unsaturated carboxylic acid (such as acrylic acid, methacrylic acid, itaconic acid, crotonic acid, isocrotonic acid or maleic acid) with a polyvalent alcohol compound, amides of an unsaturated carboxylic acid with a polyvalent amine compound, etc.

Further, addition products of an unsaturated carboxylic acid ester or amide having a nucleophilic substituent such as a hydroxy group, an amino group or a mercapto group with a monofunctional or polyfunctional isocyanate compound or an epoxy compound, dehydrating condensation products with a monofunctional or polyfunctional carboxylic acid, etc. are preferably used.

Examples of methacrylic acid esters include tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, diethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane, and bis[p-(methacryloxyethoxy)phenyl]dimethylmethane.

Examples of the itaconic acid ester include ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate.

Examples of the crotonic acid ester include ethylene glycol dicrotonate, tetramethylene glycol dicrotonate, pentaerythritol dicrotonate, and sorbitol tetracrotonate.

Examples of the isocrotonic acid ester include ethylene glycol diisocrotonate, pentaerythritol diisocrotonate, and sorbitol tetraisocrotonate.

Examples of the maleic acid ester include ethylene glycol dimaleate, triethylene glycol dimaleate, pentaerythritol dimaleate, and sorbitol tetramaleate.

As examples of other esters, for example, aliphatic alcohol-based esters described in JP-B-46-27926 (JP-B denotes a Japanese examined patent application publication), JP-B-51-47334, and JP-A-57-196231, those having an aromatic skeleton described in JP-A-59-5240, JP-A-59-5241, and JP-A-2-226149, and those containing an amino group described in JP-A-1-165613 may suitably be used.

Specific examples of an amide monomer from an aliphatic polyvalent amine compound and an unsaturated carboxylic acid include methylene bis(meth)acrylamide, 1,6-hexamethylene bis(meth)acrylamide, diethylenetriamine tris(meth)acrylamide, and xylylene bis(meth)acrylamide.

Examples of other preferred amide-based ethylenically unsaturated compound include those having a cyclohexylene structure described in JP-B-54-21726.

Furthermore, as a polyfunctional ethylenically unsaturated compound, a urethane-based addition-polymerizable polyfunctional monomer produced by an addition reaction of an isocyanate and a hydroxy group is also suitable. Specific examples thereof include a urethane-based ethylenically unsaturated compound containing two or more ethylenically unsaturated groups per molecule in which a polyisocyanate compound having two or more isocyanato groups per molecule described in JP-B-48-41708 is added to a hydroxy group-containing ethylenically unsaturated compound represented by Formula (A) below.

CH₂═C(R)COOCH₂CH(R′)OH (A)

(R and R′ denote H or CH₃.)

Furthermore, urethane acrylates described in JP-A-51-37193, JP-B-2-32293, and JP-B-2-16765, and urethane compounds having an ethylene oxide chain described in JP-B-58-49860, JP-B-56-17654, JP-B-62-39417, and JP-B-62-39418 are also suitable.

Furthermore, by use of a polyfunctional ethylenically unsaturated compounds having an amino structure or sulfide structure in the molecule described in JP-A-63-277653, JP-A-63-260909, and JP-A-1-105238, a resin composition for laser engraving which can crosslink in a short time can be obtained.

Other examples of the polyfunctional ethylenically unsaturated compound include polyester acrylates such as those described in JP-A-48-64183, JP-B-49-43191, and JP-B-52-30490, and polyfunctional acrylates and methacrylates such as epoxy acrylates etc. formed by a reaction of an epoxy resin and (meth)acrylic acid. Examples also include specific unsaturated compounds described in JP-B-46-43946, JP-B-1-40337, and JP-B-1-40336, and vinylphosphonic acid-based compounds described in JP-A-2-25493. In some cases, perfluoroalkyl group-containing structures described in JP-A-61-22048 are suitably used. Moreover, those described as photocuring monomers or oligomers in the Journal of the Adhesion Society of Japan, Vol. 20, No. 7, pp. 300 to 308 (1984) may also be used.

Specific examples of a radical polymerizable compound employable for the present invention include saturated bridged cyclic polyfunctional monomers.

As the saturated bridged cyclic polyfunctional monomer, the use of an alicyclic polyfunctional monomer having a condensed ring structure such as a compound having a bicyclo ring or a tricyclo ring structure having two methacryloyloxy groups or acryloyloxy groups is preferable from the viewpoint of controlling the physical properties.

Examples of the bicyclo rings or tricyclo rings include alicyclic hydrocarbon structures of a condensed ring structure such as norbornene skeleton (bicyclo[2.2.1]heptane), dicyclopentadiene skeleton (tricyclo[5.2.1.0^{2,6}]decane), adamantine skeleton (tricyclo[3.3.1.1^{3,7}]decane).

As the saturated bridged cyclic polyfunctional monomer, an amino group may be bonded to a bicyclo ring or a tricyclo ring directly, or via a aliphatic part of alkylene etc. such as methylene or ethylene. Moreover, a hydrogen atom of an alicyclic hydrocarbon group of these condensed ring structures may be substituted by an alkyl group etc.

In the present invention, the saturated bridged cyclic polyfunctional monomer is preferably an alicyclic polyfunctional monomer selected from the compounds below.

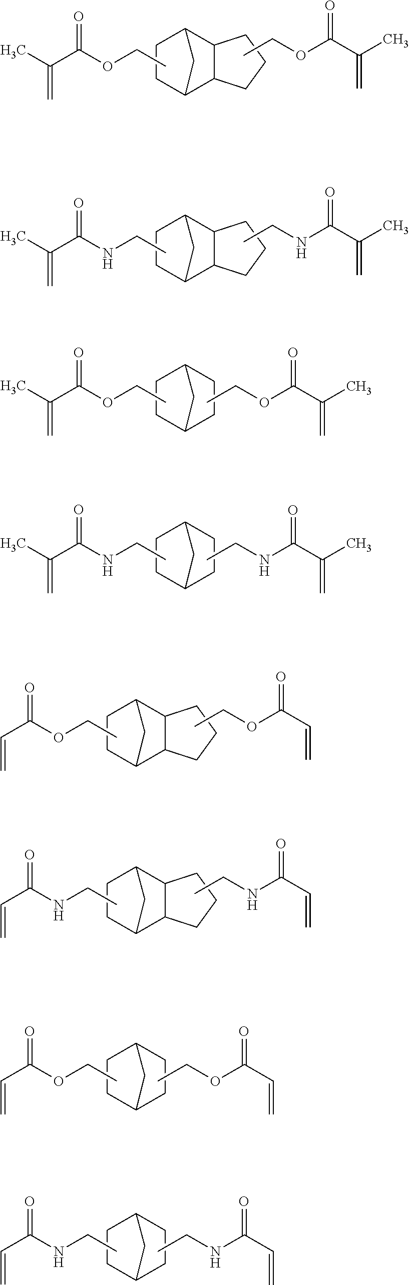

Moreover, as a radically polymerizable compound, addition reaction products of unsaturated carboxylic acid esters or amides having an electrophilic substituent such as an isocyanato group or an epoxy group with monofunctional or polyfunctional alcohols, amines or thiols, and substitution reaction products of unsaturated carboxylic acid esters or amides having a leaving group such as a halogen group or a tosyloxy group with monofunctional or polyfunctional alcohols, amines, or thiols are also favorable.

Moreover, as another example, the use of compounds obtained by replacing the unsaturated carboxylic acid with an unsaturated phosphonic acid, styrene, vinyl ether or the like is also possible.

As the polymerizable compound, the above examples of compound and various known compounds can be used without any particular limitation, and for example, compounds disclosed in paragraphs 0098 to 0124 of JP-A-2009-204962 may be used.

From the viewpoint of improving engraving sensitivity, it is preferable in the present invention to use as the radically polymerizable compound a compound having a sulfur atom in the molecule.

As such a radically polymerizable compound having a sulfur atom in the molecule, it is preferable from the viewpoint of improving engraving sensitivity in particular to use a radically polymerizable compound having two or more ethylenically unsaturated bonds and having a carbon-sulfur bond at a site where two ethylenically unsaturated bonds among them are linked (hereinafter, called a ‘sulfur-containing polyfunctional monomer’ as appropriate).

Examples of carbon-sulfur bond-containing functional groups of the sulfur-containing polyfunctional monomer in the present invention include sulfide, disulfide, sulfoxide, sulfonyl, sulfonamide, thiocarbonyl, thiocarboxylic acid, dithiocarboxylic acid, sulfamic acid, thioamide, thiocarbamate, dithiocarbamate, and thiourea-containing functional groups.

Furthermore, a linking group containing a carbon-sulfur bond linking two ethylenically unsaturated bonds of the sulfur-containing polyfunctional monomer is preferably a linking group containing at least one unit selected from —C—S—, —C—S—S—, —NHC(═S)O—, —NHC(═O)S—, —NHC(═S)S—, and —C—SO₂—.

Moreover, the number of sulfur atoms contained in the sulfur-containing polyfunctional monomer molecule is not particularly limited as long as it is one or more, and may be selected as appropriate according to the intended application, but from the viewpoint of a balance between engraving sensitivity and solubility in a coating solvent it is preferably 1 to 10, more preferably 1 to 5, and yet more preferably 1 or 2.

On the other hand, the number of ethylenically unsaturated bond sites contained in the molecule is not particularly limited as long as it is two or more and may be selected as appropriate according to the intended application, but from the viewpoint of flexibility of a crosslinked film it is preferably 2 to 10, more preferably 2 to 6, and yet more preferably 2 to 4.

From the viewpoint of flexibility of a film that is formed, the molecular weight of the sulfur-containing polyfunctional monomer in the present invention is preferably 120 to 3,000, and more preferably 120 to 1,500.

Furthermore, the sulfur-containing polyfunctional monomer in the present invention may be used on its own or as a mixture with a polyfunctional polymerizable compound or monofunctional polymerizable compound having no sulfur atom in the molecule.

Moreover, examples of the polymerizable compound having a sulfur atom in the molecule include those described in paragraphs 0032 to 0037 of JP-A-2009-255510, and these compounds descried therein may be used in the present invention.

With regard to Component B in the resin composition of the present invention, one type may be used on its own or two or more types may be used in combination.

The amount of Component B contained in the resin composition of the present invention is preferably 2 to 50 wt % relative to the total solids content, more preferably 5 to 30 wt %, and particularly preferably 10 to 20 wt %.

### <(Component C) Radical Polymerization Initiator>

The resin composition for laser engraving of the present invention comprises (Component C) a radical polymerization initiator.

With regard to the polymerization initiator, one known to a person skilled in the art may be used without any limitations. Radical polymerization initiators, which are preferred polymerization initiators, are explained in detail below, but the present invention should not be construed as being limited to these descriptions.

The radical polymerization initiator may be a radical photopolymerization initiator or a radical thermopolymerization initiator, and is preferably a radical thermopolymerization initiator.

In the present invention, preferable radical polymerization initiators include (a) aromatic ketones, (b) onium salt compounds, (c) organic peroxides, (d) thio compounds, (e) hexaallylbiimidazole compounds, (f) ketoxime ester compounds, (g) borate compounds, (h) azinium compounds, (i) metallocene compounds, (j) active ester compounds, (k) compounds having a carbon halogen bond, and (l) azo compounds. Hereinafter, although specific examples of the (a) to (l) are cited, the present invention is not limited to these.

In the present invention, when applies to the relief-forming layer of the relief printing plate precursor, from the viewpoint of engraving sensitivity and making a favorable relief edge shape, (c) organic peroxides and (l) azo compounds are more preferable, and (c) organic peroxides are particularly preferable.

The (a) aromatic ketones, (b) onium salt compounds, (d) thio compounds, (e) hexaallylbiimidazole compounds, (f) ketoxime ester compounds, (g) borate compounds, (h) azinium compounds, (i) metallocene compounds, (j) active ester compounds, and (k) compounds having a carbon halogen bonding may preferably include compounds described in paragraphs 0074 to 0118 of JP-A-2008-63554.

Moreover, (c) organic peroxides and (l) azo compounds preferably include the following compounds.

### (C) Organic Peroxide

Preferred examples of the organic peroxide (c) as a radical polymerization initiator that can be used in the present invention include peroxyester-based ones such as 3,3′,4,4′-tetra(tertiary-butylperoxycarbonyl)benzophenone, 3,3′,4,4′-tetra(tertiary-amylperoxycarbonyl)benzophenone, 3,3′,4,4′-tetra(tertiary-hexylperoxycarbonyl)benzophenone, 3,3′,4,4′-tetra(tertiary-octylperoxycarbonyl)benzophenone, 3,3′,4,4′-tetra(cumylperoxycarbonyl)benzophenone, 3,3′,4,4′-tetra(p-isopropylcumylperoxycarbonyl)benzophenone, and di-tertiary-butyldiperoxyisophthalate.

### (l) Azo Compounds

Preferable (l) azo compounds as a radical polymerization initiator that can be used in the present invention include those such as 2,2′-azobisisobutyronitrile, 2,2′-azobispropionitrile, 1,1′-azobis(cyclohexane-1-carbonitrile), 2,2′-azobis(2-methylbutyronitrile), 2,2′-azobis(2,4-dimethylvaleronitrile), 2,2′-azobis(4-methoxy-2,4-dimethylvaleronitrile), 4,4′-azobis(4-cyanovaleric acid), dimethyl 2,2′-azobis(isobutyrate), 2,2′-azobis(2-methylpropionamideoxime), 2,2′-azobis[2-(2-imidazolin-2-yl)propane], 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N-butyl-2-methylpropionamide), 2,2′-azobis(N-cyclohexyl-2-methylpropionamide), 2,2′-azobis[N-(2-propenyl)-2-methyl-propionamide], 2,2′-azobis(2,4,4-trimethylpentane).

In the present invention, the organic peroxide (c) is particularly preferable as the polymerization initiator in the present invention from the viewpoint of crosslinking properties of the film (relief-forming layer) and improving the engraving sensitivity.

From the viewpoint of the engraving sensitivity, an embodiment obtained by combining (c) an organic peroxide and a polymer having a glass transition temperature of normal temperature (20° C.) or greater as (Component D) a binder polymer is particularly preferable.

This is presumed as follows. When the relief-forming layer is cured by thermal crosslinking using an organic peroxide, an organic peroxide that did not play a part in radical generation and has not reacted remains, and the remaining organic peroxide works as an autoreactive additive and decomposes exothermally in laser engraving. As the result, energy of generated heat is added to the irradiated laser energy to thus raise the engraving sensitivity.

It is surmised that, in particular, when the glass transition temperature of the binder polymer is normal temperature (20° C.) or higher, heat generated as a result of decomposition of an organic peroxide is efficiently transmitted to the binder polymer and utilized effectively for thermal decomposition of the binder polymer itself, thus increasing the sensitivity.

It will be described in detail in the explanation of photothermal converting agent, the effect thereof is remarkable when carbon black is used as the photothermal converting agent. It is considered that the heat generated from the carbon black is also transmitted to (c) an organic peroxide and, as the result, heat is generated not only from the carbon black but also from the organic peroxide, and that the generation of heat energy to be used for the decomposition of binder polymers, etc. occurs synergistically.

Since an engraving sensitivity is greatly increased, use of an organic peroxide and a photothermal conversion agent, which is described later, in combination is preferable, and it is most preferable to employ a mode in which an organic peroxide and carbon black, which is a photothermal conversion agent, are used in combination.

When a relief-forming layer is cured by thermal crosslinking using an organic peroxide, unreacted organic peroxide that is not involved in radical formation may remain, and the remaining organic peroxide functions as a self-reactive additive and decomposes exothermically during laser engraving. It is surmised that, as a result, an amount corresponding to the heat generated is added to the irradiated laser energy, and the engraving sensitivity is thus increased.

It will be described in the explanation of photothermal converting agent, this effect is outstanding when carbon black is used as a photothermal conversion agent. It is surmised that, as a result of heat generated from carbon black being transmitted to an organic peroxide, heat is generated not only from the carbon black but also from the organic peroxide, and thermal energy that is used for decomposition of Component B etc. is generated synergistically.

Component C in the resin composition of the present invention may be used singly or in a combination of two or more compounds.

The content of Component C in the resin composition of the present invention is preferably 0.1 to 5 wt % relative to the total weight of the solids content, more preferably 0.3 to 3 wt %, and particularly preferably 0.5 to 1.5 wt %.

### <(Component D) A Binder Polymer>

A resin composition for raser engraving of the present invention comprises (Component D) a binder polymer.

A binder polymer is a polymer component contained in resin composition for raser engraving.

The number-average molecular weight (Mn) of the binder polymer is preferably 500 to 5,000,000.

The weight-average molecular weight (In polystyrene equivalent by GPC measurement) of the binder polymer is preferably less than 1,000, more preferably is 5,000 to 5,000,000, yet more preferably is 10,000 to 4,000,000, and particularly preferably is 150,000 to 3,000,000.

Examples of binder is a polystyrene resin, polyester resin, polyamide resin, polyurea resin, polyamide imide resin, polyurethane resin, polysulfone resin, polyether sulfone resin, polyimide resin, polycarbonate resin, hydroxyethylene unit-containing hydrophilic polymer, acrylic resin, acetal resin, epoxy resin, polycarbonate resin, rubber, thermoplastic elastomer, etc.

A binder polymer used in the present invention is preferably binder polymer having a group having hydroxyl group, alkoxyl group, hydrolyzable silyl group and/or a silanol group.

The functional group may be present in any part of the polymer molecule, but particularly preferably lies on the side chain of the chain polymer. As such polymers, vinyl copolymers (copolymers of vinyl monomers such as polyvinyl alcohol and polyvinyl acetal, and derivatives thereof) and acrylic resins (copolymers of acrylic monomers such as hydroxyethyl(meth)acrylate, and derivatives thereof) may be preferably used. A derivative of a copolymer of vinyl monomers specifically denotes a binder polymer extended a side chain by a chemical modification at hydroxy group or α-position of hydroxy group of vinyl alcohol unit and introduced a functional group, which is reactable with a condensable group of Component A, such as hydroxy group or carboxy group at a terminal thereof.

A process for producing the binder polymer that can be used in the present invention is not particularly limited, and examples include a method in which it is produced by polymerization or copolymerization of a polymerizable monomer having a group that can react with the condensable group of Component A.

A binder polymer used in the present invention is particularly preferably a binder polymer having a hydroxyl group.

### {Binder Polymer Having a Hydroxyl Group}

Hereinafter, a binder polymer having a hydroxyl group (hereinafter, appropriately also referred to as a “specific polymer”) will be explained. This binder polymer is preferably insoluble in water and soluble in alcohol having 1 to 4 carbon atoms.

As specific polymer, from the view point of satisfying both good durability properties for an aqueous ink and for a UV ink, and having a high engraving sensitivity and good film performance, polyvinyl butyral (PVB) and derivatives thereof, acrylic resins having a hydroxyl group on a side chain, epoxy resins having a hydroxyl group on a side chain, etc. are preferable.

A specific polymer used in the present invention is particularly preferable for improvement of engraving sensitivity when combined with a photothermal conversion agent described below at a glass transition temperature (Tg) of at least 20° C. A binder polymer having such a glass transition temperature is also called a non-elastomer below. That is, generally, an elastomer is academically defined as a polymer having a glass transition temperature of no greater than 20° C. (room temperature) (ref. Kagaku Dai Jiten 2^{nd} edition (Science Dictionary), Foundation for Advancement of International Science, Maruzen, P. 154). Non-elastomer refers to a polymer which a glass transition temperature of greater than room temperature. The upper limit for the glass transition temperature of the polymer is not limited, but is preferably no greater than 200° C. from the viewpoint of ease of handling, and is more preferably at least 25° C. but no greater than 120° C.

When a polymer having a glass transition temperature of normal temperature (20° C.) or greater is used, a specific polymer is in a glass state at less than normal temperature (20° C.). Because of this, compared with a case of the rubber state, thermal molecular motion is suppressed. In laser engraving, in addition to the heat given by a laser during laser irradiation, heat generated by the function of a photothermal conversion agent added as desired is transmitted to the surrounding specific polymer, and this polymer is thermally decomposed and disappears, thereby forming an engraved recess.

In preferred mode of the present invention, it is surmised that when a photothermal conversion agent is present in a state in which thermal molecular motion of a specific polymer is suppressed, heat transfer to and thermal decomposition of the specific polymer occur effectively. It is anticipated that such an effect further increases the engraving sensitivity.

Specific examples of polymers that are non-elastomer for use preferably in the present invention are cited below.

### (1) Polyvinyl Acetal and its Derivative

In this description, hereinafter, polyvinyl acetal and derivatives thereof are called just a polyvinyl acetal derivative. That is, a polyvinyl acetal derivative includes polyvinyl acetal and derivatives thereof, and is a generic term used to refer to compounds obtained by converting polyvinyl alcohol (obtained by saponifying polyvinyl acetate) into a cyclic acetal.

The acetal content in the polyvinyl acetal derivative (mole % of vinyl alcohol units converted into acetal relative to the total number of moles of vinyl acetate monomer starting material as 100 mol %) is preferably 30 to 90 mol %, more preferably 50 to 85 mol %, and particularly preferably 55 to 78 mol %.

The vinyl alcohol unit in the polyvinyl acetal is preferably 10 to 70 mol % relative to the total number of moles of the vinyl acetate monomer starting material, more preferably 15 to 50 mol %, and particularly preferably 22 to 45 mol %.

Furthermore, the polyvinyl acetal may have a vinyl acetate unit as another component, and the content thereof is preferably 0.01 to 20 mol %, and more preferably 0.1 to 10 mol %. The polyvinyl acetal derivative may further have another copolymerized constitutional unit.

Examples of the polyvinyl acetal derivative include a polyvinyl butyral derivative, a polyvinyl propylal derivative, a polyvinyl ethylal derivative, and a polyvinyl methylal derivative. Among them, a polyvinyl butyral derivative (hereinafter, it is also referred to as a “PVB derivative”) is a derivative that is preferable. In this description, for examples, a polyvinyl butyral derivative includes polyvinyl butyral and derivatives thereof, and the same can be said for other polyvinyl acetal derivatives.

From the viewpoint of a balance being achieved between engraving sensitivity and film formation properties, the weight-average molecular weight of the polyvinyl acetal derivative is preferably 5,000 to 800,000, more preferably 8,000 to 500,000 and, from the viewpoint of improvement of rinsing properties for engraving residue, particularly preferably 50,000 to 300,000.

Preferable examples of a polyvinyl butyral derivative are cited for explanation, but there are not limited to these.

An example of structure of polyvinyl butyral derivatives is shown below, and is constituted while including these constitutional units. l is preferably more than 50 mol %.

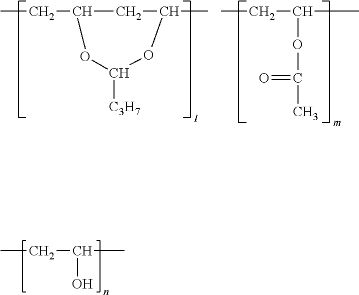

Derivatives of PVB are available as a commercial product. As specific examples, from the viewpoint of alcohol (in particular, ethanol) solubility, “Eslec B” series and “Eslec K (KS)” series (Sekisui Chemical Co., Ltd.) and “Denka Butyral” (Denki Kagaku Kogyo K.K.) are preferable, and, from the viewpoint of alcohol (in particular, ethanol) solubility, “Eslec B” series (Sekisui Chemical Co., Ltd.) and “Denka Butyral” (Denki Kagaku Kogyo K.K.) are more preferable.

Among these, particularly preferable commercial products are shown below with values of L, m and n in Formula above and molecular weight. With regard to “Eslec B” series (Sekisui Chemical Co., Ltd.), “BL-1” (l=61, m=3, n=36, weight average molecular weight: 19,000), “BL-1H” (l=67, m=3, n=30, weight average molecular weight: 20,000), “BL-2” (l=61, m=3, n=36, weight average molecular weight: about 27,000), “BL-5” (l=75, m=4, n=21, weight average molecular weight: 32,000), “BL-S” (l=74, m=4, n=22, weight average molecular weight: 23,000), “BM-S” (l=73, m=5, n=22, weight average molecular weight: 53,000), “BH-S” (l=73, m=5, n=22, weight average molecular weight: 66,000) are cited. With regard to “Denka Butyral” series (Denki Kagaku Kogyo K.K.), “#3000-1” (l=71, m=1, n=28, weight average molecular weight: 74,000), “#3000-2” (l=71, m=1, n=28, weight average molecular weight: 90,000), “#3000-4” (l=71, m=1, n=28, weight average molecular weight: 117,000), “#4000-2” (l=71, m=1, n=28, weight average molecular weight: 152,000), “#6000-C” (l=64, m=1, n=35, weight average molecular weight: 308,000), “#6000-EP” (l=56, m=15, n=29, weight average molecular weight: 381,000), “#6000-CS” (l=74, m=1, n=25, weight average molecular weight: 322,000), “#6000-AS” (l=73, m=1, n=26, weight average molecular weight: 242,000) are cited.

When the relief-forming layer is formed using PVB as the specific polymer, a method of casting and drying a solution prepared by solving it in a solvent is preferable from the viewpoint of the flatness of the film surface.

### (2) An Acrylic Resin

As binder polymer, an acrylic resin may be used.

As acrylic resin, acrylic resin having hygroxy group is preferable.

Preferable examples of the acrylic monomer having a hydroxy group include a (meth)acrylic acid ester, a crotonic acid ester, or a (meth)acrylamide that has a hydroxy group in the molecule. Specific examples of such a monomer include 2-hydroxyethyl (meth)acrylate, 2-hydroxypropyl (meth)acrylate, and 4-hydroxybutyl (meth)acrylate.

As acrylic resin, the acrylic monomer other than that having hydroxy group may comprises as a co-monomer. Examples thereof such an acrylic monomer include, as the (meth)acrylic ester, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-hexyl (meth)acrylate, 2-ethylhexyl (meth)acrylate, acetoxyethyl (meth)acrylate, phenyl (meth)acrylate, 2-methoxyethyl (meth)acrylate, 2-ethoxyethyl (meth)acrylate, 2-(2-methoxyethoxy)ethyl (meth)acrylate, cyclohexyl (meth)acrylate, benzyl (meth)acrylate, diethylene glycol monomethyl ether (meth)acrylate, diethylene glycol monoethyl ether (meth)acrylate, diethylene glycol monophenyl ether (meth)acrylate, triethylene glycol monomethyl ether (meth)acrylate, triethylene glycol monoethyl ether (meth)acrylate, dipropylene glycol monomethyl ether (meth)acrylate, polyethylene glycol monomethyl ether (meth)acrylate, polypropylene glycol monomethyl ether (meth)acrylate, the monomethyl ether (meth)acrylate of a copolymer of ethylene glycol and propylene glycol, N,N-dimethylaminoethyl (meth)acrylate, N,N-diethylaminoethyl (meth)acrylate, and N,N-dimethylaminopropyl (meth)acrylate.

Furthermore, a modified acrylic resin formed with a urethane group- or urea group-containing acrylic monomer may preferably be used.

Among these, from the viewpoint of aqueous ink resistance, an alkyl (meth)acrylate such as lauryl (meth)acrylate and an aliphatic cyclic structure-containing (meth)acrylate such as t-butylcyclohexyl (meth)acrylate are particularly preferable.

Furthermore, as the specific polymer, a novolac resin may be used, this being a resin formed by condensation of a phenol and an aldehyde under acidic conditions.

Preferred examples of the novolac resin include a novolac resin obtained from phenol and formaldehyde, a novolac resin obtained from m-cresol and formaldehyde, a novolac resin obtained from p-cresol and formaldehyde, a novolac resin obtained from o-cresol and formaldehyde, a novolac resin obtained from octylphenol and formaldehyde, a novolac resin obtained from mixed m-/p-cresol and formaldehyde, and a novolac resin between a mixture of phenol/cresol (any of m-, p-, o- or m-/p-, m-/o-, o-/p-mixtures) and formaldehyde.

With regard to these novolac resins, those having a weight-average molecular weight of 800 to 200,000 and a number-average molecular weight of 400 to 60,000 are preferable.

An epoxy resin having a hydroxy group in a side chain may be used as a specific polymer. A preferred example of the epoxy resin is an epoxy resin formed by polymerization, as a starting material monomer, of an adduct of bisphenol A and epichlorohydrin. The epoxy resin preferably has a weight-average molecular weight of at least 800 but no greater than 200,000, and a number-average molecular weight of at least 400 but no greater than 60,000.

Among specific polymers, polyvinyl butyral derivatives are particularly preferable from the viewpoint of rinsing properties and printing durability when the polymer is formed into the relief-forming layer.

In polymers of any embodiment described above, the content of the hydroxyl group contained in the specific polymer in the present invention is preferably 0.1 to 15 mmol/g, and more preferably 0.5 to 7 mmol/g.

Component D in the resin composition of the present invention may be used only in one kind, or in two or more kinds in combination.

The content of Component D in the resin composition of the present invention is preferably 10 to 50 wt % relative to the total weight of the solids content of the resin composition, more preferably 15 to 45 wt %, and particularly preferably 20 to 40 wt %.

<(Component E) Compound Having Two or More Hydrolyzable Silyl Groups and/or Silanol Groups>

The resin composition for laser engraving of the present invention preferably comprises (Component E) a compound having two or more hydrolyzable silyl groups and/or silanol groups.

Furthermore, Component E does not have a chain transfer group.

The hydrolyzable silyl group or silanol group in Component E is preferably a group represented by Formula (1) above.

The total number of hydrolyzable silyl groups and silanol groups in Component E is at least two, preferably 2 to 6, and more preferably 2 or 3.

Furthermore, the preferred mode for Formula (1) in A above also applies to Formula (1) in Component E.

Component E in the present invention is preferably a compound having at least one group represented by Formula (1) above, and more preferably a compound having two or more groups. In particular, a compound having two or more hydrolyzable silyl groups is preferably used. That is, a compound having in the molecule two or more silicon atoms having a hydrolyzable group bonded thereto is preferably used.

Component E preferably has at least a sulfur atom, an ester bond, a urethane bond, an ether bond, a urea bond, or an imino group.

Among them, from the viewpoint of crosslinkability, Component E preferably comprises a sulfur atom, and from the viewpoint of removability (rinsing properties) of engraving residue it is preferable for it to comprise an ester bond, a urethane bond, or an ether bond (in particular, an ether bond contained in an oxyalkylene group), which is easily decomposed by aqueous alkali.

Furthermore, Component E in the present invention is preferably a compound that does not have an ethylenically unsaturated bond.

As Component E in the present invention, there can be cited a compound in which a plurality of groups represented by Formula (1) above are bonded via a divalent linking group, and from the viewpoint of the effect, such a divalent linking group is preferably a linking group having a sulfide group (—S—), an imino group (—N(R)—) or a urethane bond (—OCON(R)— or —N(R)COO—). R denotes a hydrogen atom or a substituent. Examples of the substituent denoted by R include an alkyl group, an aryl group, an alkenyl group, an alkynyl group, and an aralkyl group.

A method for synthesizing Component E is not particularly limited, and synthesis can be carried out by a known method. As one example, a representative synthetic method for a Component E containing a linking group having the above-mentioned specific structure is shown below.

<Synthetic Method for Compound Having Sulfide Group as Linking Group and Having Hydrolyzable Silyl Group and/or Silanol Group>

A synthetic method for a Component E having a sulfide group as a linking group (hereinafter, called as appropriate a ‘sulfide linking group-containing Component E’) is not particularly limited, but specific examples thereof include reaction of a Component E having a halogenated hydrocarbon group with an alkali metal sulfide, reaction of a Component E having a mercapto group with a halogenated hydrocarbon, reaction of a Component E having a mercapto group with a Component E having a halogenated hydrocarbon group, reaction of a Component E having a halogenated hydrocarbon group with a mercaptan, reaction of a Component E having an ethylenically unsaturated double bond with a mercaptan, reaction of a Component E having an ethylenically unsaturated double bond with a Component E having a mercapto group, reaction of a compound having an ethylenically unsaturated double bond with a Component E having a mercapto group, reaction of a ketone with a Component E having a mercapto group, reaction of a diazonium salt with a Component E having a mercapto group, reaction of a Component E having a mercapto group with an oxirane, reaction of a Component E having a mercapto group with a Component E having an oxirane group, reaction of a mercaptan with a Component E having an oxirane group, and reaction of a Component E having a mercapto group with an aziridine.

<Synthetic Method for Compound Having Imino Group as Linking Group and Having Hydrolyzable Silyl Group and/or Silanol Group>

A synthetic method for a Component E having an imino group as a linking group (hereinafter, called as appropriate an ‘imino linking group-containing Component E’) is not particularly limited, but specific examples include reaction of a Component E having an amino group with a halogenated hydrocarbon, reaction of a Component E having an amino group with a Component E having a halogenated hydrocarbon group, reaction of a Component E having a halogenated hydrocarbon group with an amine, reaction of a Component E having an amino group with an oxirane, reaction of a Component E having an amino group with a Component E having an oxirane group, reaction of an amine with a Component E having an oxirane group, reaction of a Component E having an amino group with an aziridine, reaction of a Component E having an ethylenically unsaturated double bond with an amine, reaction of a Component E having an ethylenically unsaturated double bond with a Component E having an amino group, reaction of a compound having an ethylenically unsaturated double bond with a Component E having an amino group, reaction of a compound having an acetylenically unsaturated triple bond with a Component E having an amino group, reaction of a Component E having an imine-based unsaturated double bond with an organic alkali metal compound, reaction of a Component E having an imine-based unsaturated double bond with an organic alkaline earth metal compound, and reaction of a carbonyl compound with a Component E having an amino group.

<Synthetic Method for Compound Having Urea Bond (Ureylene Group) as Linking Group and Having Hydrolyzable Silyl Group and/or Silanol Group>

A synthetic method for Component E having an ureylene group (hereinafter, called as appropriate a ‘ureylene linking group-containing Component E’) as a linking group is not particularly limited, but specific examples include synthetic methods such as reaction of a Component E having an amino group with an isocyanate ester, reaction of a Component E having an amino group with a Component E having an isocyanate ester, and reaction of an amine with a Component E having an isocyanate ester.

Component E is preferably a compound represented by Formula (E-1) or Formula (E-2) below.

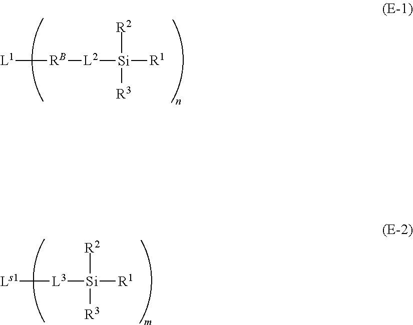

(In Formula (E-1) and Formula (E-2), R^{B} denotes an ester bond, an amide bond, a urethane bond, a urea bond, or an imino group, L¹ denotes an n-valent linking group, L² denotes a divalent linking group, L^{s1} denotes an m-valent linking group, L³ denotes a divalent linking group, n and m independently denote an integer of 1 or greater, and R¹ to R³ independently denote a hydrogen atom, a halogen atom, or a monovalent organic substituent. In addition, at least one of R¹ to R³ denotes a hydrolyzable group selected from the group consisting of an alkoxy group, a mercapto group, a halogen atom, an amide group, an acetoxy group, an amino group, and an isopropenoxy group, or a hydroxy group.)

R¹ to R³ in Formula (E-1) and Formula (E-2) above have the same meanings as those of R¹ to R³ in Formula (1) above, and preferred ranges are also the same.

From the viewpoint of rinsing properties and film strength, R^{B} above is preferably an ester bond or a urethane bond, and is more preferably an ester bond.

The divalent or n-valent linking group denoted by L¹ to L³ above is preferably a group formed from at least one type of atom selected from the group consisting of a carbon atom, a hydrogen atom, an oxygen atom, a nitrogen atom, and a sulfur atom, and is more preferably a group formed from at least one type of atom selected from the group consisting of a carbon atom, a hydrogen atom, an oxygen atom, and a sulfur atom. The number of carbon atoms of L¹ to L³ above is preferably 2 to 60, and more preferably 2 to 30.

Furthermore, L¹ above preferably does not contain a sulfur atom.

The m-valent linking group denoted by L^{s1} above is preferably a group formed from a sulfur atom and at least one type of atom selected from the group consisting of a carbon atom, a hydrogen atom, an oxygen atom, a nitrogen atom, and a sulfur atom, and is more preferably an alkylene group or a group formed by combining two or more from an alkylene group, a sulfide group, and an imino group. The number of carbon atoms of L^{s1} above is preferably 2 to 60, and more preferably 6 to 30.

n and m above are independently integers of 2 to 10, more preferably integers of 2 to 6, and particularly preferably 2.

From the viewpoint of removability (rinsing properties) of engraving residue, the n-valent linking group denoted by L¹ and/or the divalent linking group denoted by L², or the divalent linking group denoted by L³ preferably has an ether bond, and more preferably has an ether bond contained in an oxyalkylene group.

Among compounds represented by Formula (E-1) or Formula (E-2), from the viewpoint of crosslinkability, etc., the n-valent linking group denoted by L¹ and/or the divalent linking group denoted by L² in Formula (A-1) are preferably groups having a sulfur atom.

Specific examples of Component E that can be used to the present invention are shown below. Examples thereof include bis(triethoxysilylpropyl)tetrasulfide, 1,4-bis(triethoxysilyl)benzene, bis(triethoxysilyl)ethane, 1,6-bis(trimethoxysilyl)hexane, 1,8-bis(triethoxysilyl)octane, 1,2-bis(trimethoxysilyl)decane, bis(triethoxysilylpropyl)amine, and bis(trimethoxysilylpropyl)urea. Other than the above, the compounds shown below can be cited as preferred examples, but the present invention should not be construed as being limited thereto.

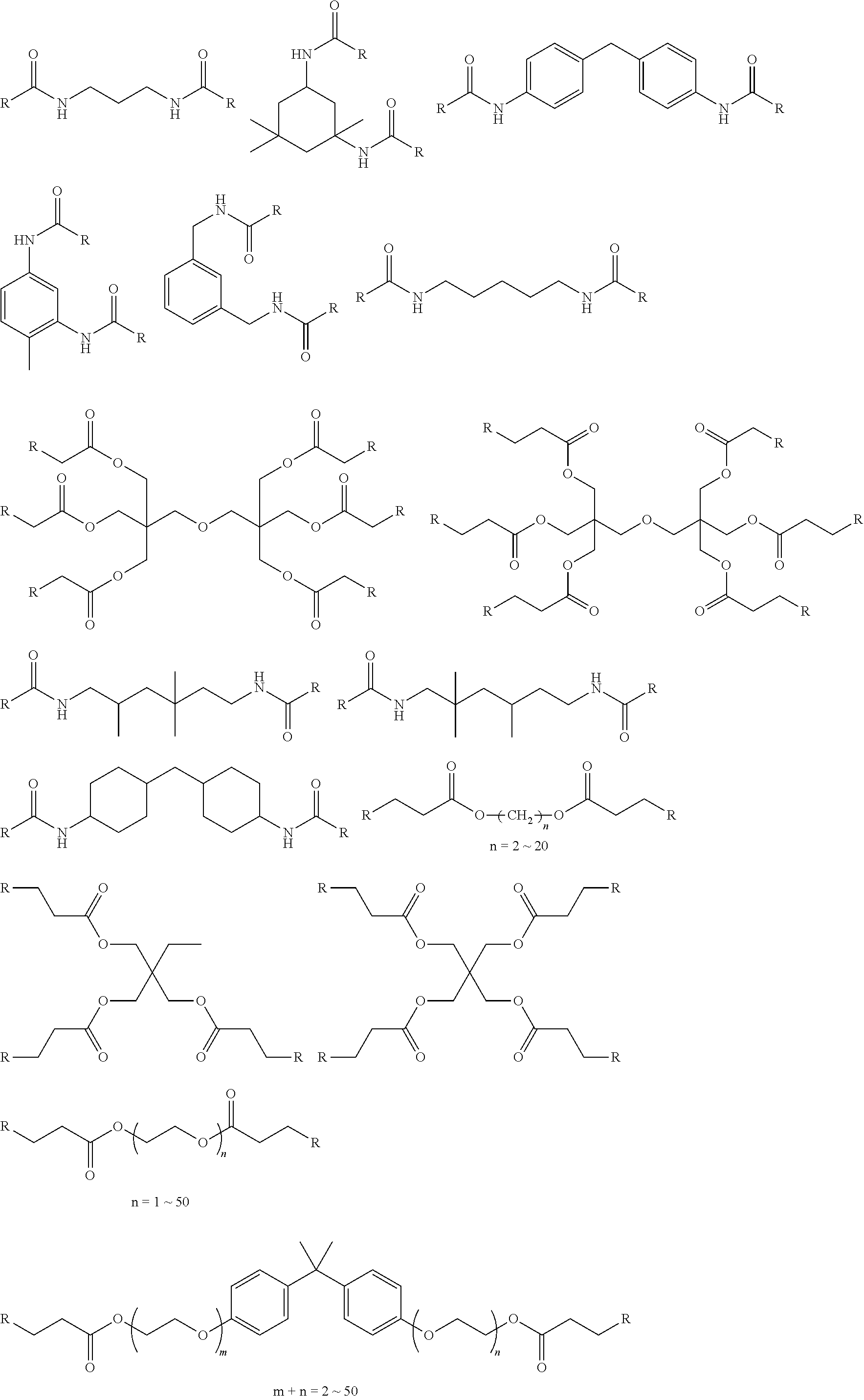

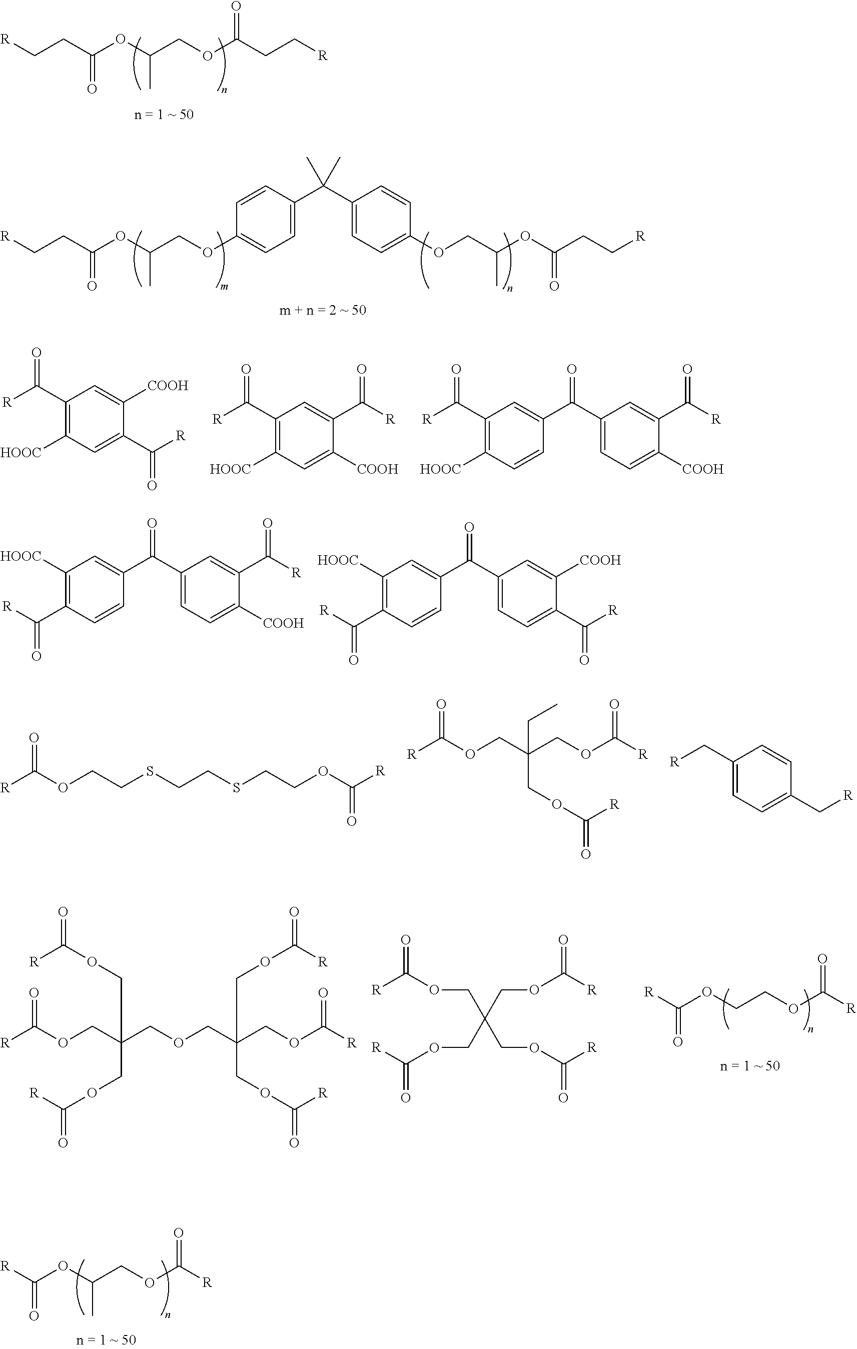

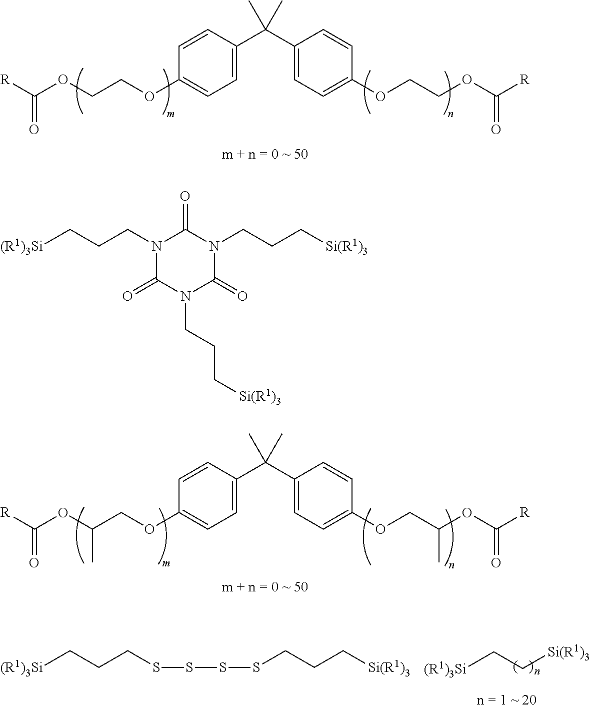

In each of the formulae above, R denotes a partial structure selected from the structures below. When a plurality of Rs and R¹s are present in the molecule, they may be identical to or different from each other, and are preferably identical to each other in terms of synthetic suitability.

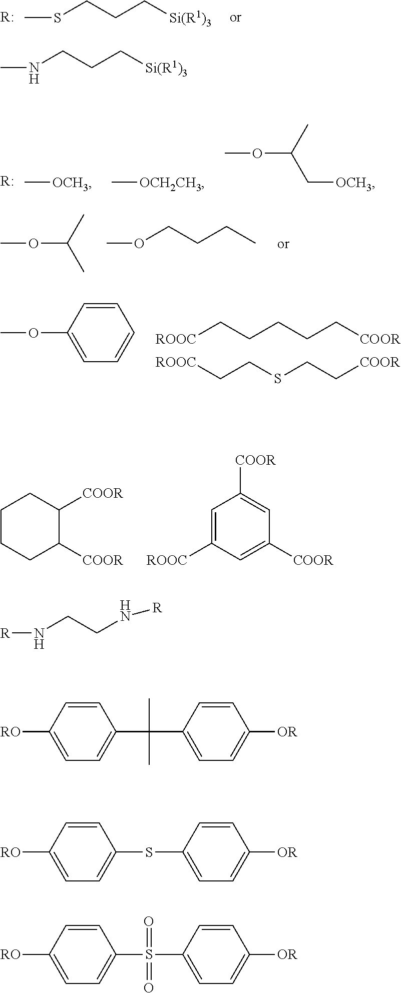

In each of the formulae above, R denotes a partial structure shown below. R¹ is the same as defined above. When a plurality of Rs and R¹s are present in the molecule, they may be identical to or different from each other, and in terms of synthetic suitability are preferably identical to each other.

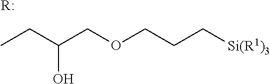

Component E may be obtained by synthesis as appropriate, but use of a commercially available product is preferable in terms of cost. Since Component E corresponds to for example commercially available silane products from Shin-Etsu Chemical Co., Ltd., Dow Corning Toray, Momentive Performance Materials Inc., Chisso Corporation, etc., the resin composition of the present invention may employ such a commercially available product by appropriate selection according to the intended application.

As Component E in the present invention, a partial hydrolysis-condensation product obtained using one type of compound having a hydrolyzable silyl group and/or a silanol group or a partial cohydrolysis-condensation product obtained using two or more types may be used. Hereinafter, these compounds may be called ‘partial (co)hydrolysis-condensation products’.

Among silane compounds as partial (co)hydrolysis-condensation product precursors, from the viewpoint of versatility, cost, and film compatibility, a silane compound having a substituent selected from a methyl group and a phenyl group as a substituent on the silicon is preferable, and specific preferred examples of the precursor include methyltrimethoxysilane, methyltriethoxysilane, phenyltrimethoxysilane, phenyltriethoxysilane, dimethyldimethoxysilane, dimethyldiethoxysilane, diphenyldimethoxysilane, and diphenyldiethoxysilane.

In this case, as a partial (co)hydrolysis-condensation product, it is desirable to use a dimer (2 moles of silane compound is reacted with 1 mole of water to eliminate 2 moles of alcohol, thus giving a disiloxane unit) to preferably 100-mer of the above-mentioned silane compound, more preferably a dimer to 50-mer, and yet more preferably a dimer to 30-mer, and it is also possible to use a partial cohydrolysis-condensation product formed using two or more types of silane compounds as starting materials.

As such a partial (co)hydrolysis-condensation product, ones commercially available as silicone alkoxy oligomers may be used (e.g. those from Shin-Etsu Chemical Co., Ltd.) or ones that are produced in accordance with a standard method by reacting a hydrolyzable silane compound with less than an equivalent of hydrolytic water and then removing by-products such as alcohol and hydrochloric acid may be used. When the production employs, for example, an acyloxysilane or an alkoxysilane described above as a hydrolyzable silane compound starting material, which is a precursor, partial hydrolysis-condensation may be carried out using as a reaction catalyst an acid such as hydrochloric acid or sulfuric acid, an alkali metal or alkaline earth metal hydroxide such as sodium hydroxide or potassium hydroxide, or an alkaline organic material such as triethylamine, and when the production is carried out directly from a chlorosilane, water and alcohol may be reacted using hydrochloric acid by-product as a catalyst.

Preferred examples of Component E that can be used in the present invention include S-1 to S-12 below. In the chemical formulae below, Et denotes an ethyl group and Me denotes a methyl group.

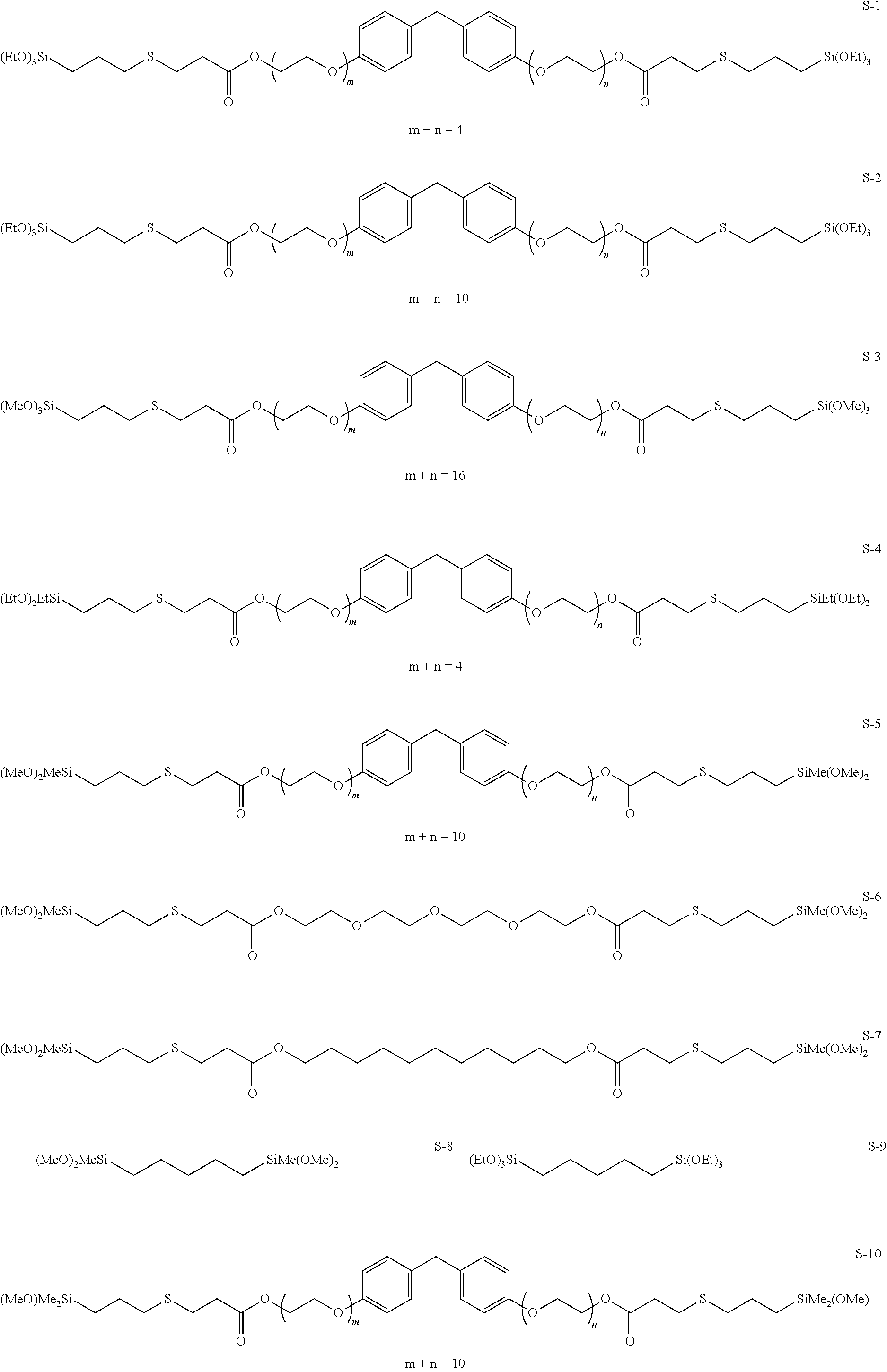

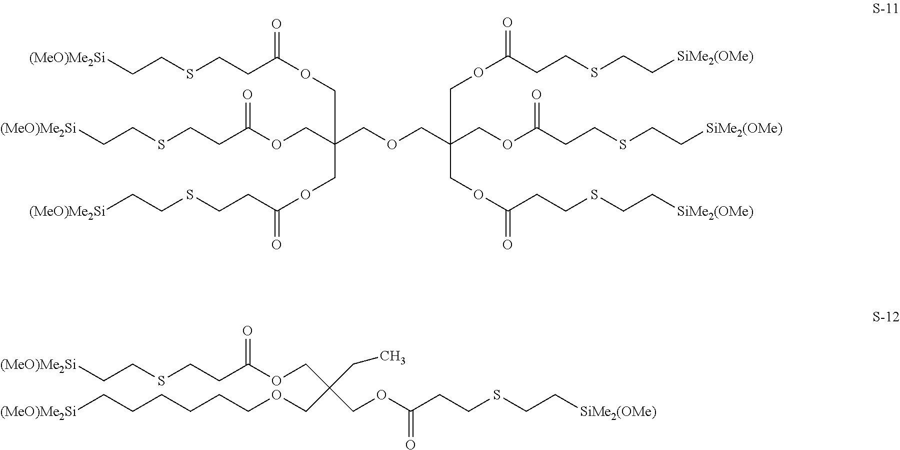

With regard to Component E in the resin composition of the present invention, one type may be used on its own or two or more types may be used in combination.

The amount of Component E contained in the resin composition of the present invention is preferably 2 to 30 wt % relative to the total solids content, more preferably 5 to 25 wt %, and particularly preferably 10 to 20 wt %.

### <Preferred Ratio by Weight of Components>

As the ratio by weight of the components in the resin composition for laser engraving of the present invention, the mode below is preferable.

Component A content/Component B content is preferably 0.01 to 10, more preferably 0.05 to 1, and particularly preferably 0.1 to 0.5.

Component C content/Component B content is preferably 0.001 to 1, more preferably 0.01 to 0.5, and particularly preferably 0.05 to 0.2.

Component D content/Component B content is preferably 0.1 to 10, more preferably 0.2 to 5, and particularly preferably 0.5 to 2.

Component E content/Component B content is preferably 0.1 to 10, more preferably 0.2 to 5, and particularly preferably 0.5 to 2.

Component E content/Component A content is preferably 0.1 to 100, more preferably 1 to 20, and particularly preferably 3 to 10.

Component C content/Component A content is preferably 0.005 to 1, more preferably 0.01 to 0.5, and particularly preferably 0.02 to 0.2.

When in these ranges, the effects of the present invention can be further exhibited.

### <(Component F) Condensation Reaction Catalyst>

The resin composition for laser engraving of the present invention preferably comprises (Component F) a condensation reaction catalyst.

The condensation reaction catalyst may be used without limitation as long as it is a reaction catalyst usually used in a condensation reaction, and preferred examples include an acidic catalyst, a basic catalyst, and a metal complex catalyst.

As the acidic catalyst and the basic catalyst, an acidic or basic compound is preferably used as it is or in the form of a solution in which it is dissolved in a solvent such as water or an organic solvent (hereinafter, also called an acidic catalyst or basic catalyst respectively). The concentration when dissolved in a solvent is not particularly limited, and it may be selected appropriately according to the properties of the acidic or basic compound used, desired catalyst content, etc.

An acidic catalyst and a basic catalyst is not particularly limited. Examples of the acidic catalyst include a hydrogen halide such as hydrochloric acid, nitric acid, sulfuric acid, sulfurous acid, hydrogen sulfide, perchloric acid, hydrogen peroxide, carbonic acid, a carboxylic acid such as formic acid or acetic acid, a carboxylic acid in which R of the structural formula RCOOH is substituted with another element or substituent, a sulfonic acid such benzenesulfonic acid, a phosphoric acid, heteropoly acid, and inorganic solid acid, etc. Examples of the basic catalyst include an ammoniacal base such as aqueous ammonia, an amine such as ethylamine or aniline, an alkali metal hydroxide, an alkali metal alkoxide, an alkaline earth metal oxide, a quaternary ammonium salt compound, and a quaternary phosphonium salt compound, etc.

The metal complex catalyst is preferably constituted from a metal element selected from Groups 2, 3, 4, and 5 of the periodic table and an oxo or hydroxy oxygen compound selected from 13-diketones (acetylacetones are preferable), ketoesters, hydroxycarboxylic acids and esters thereof, amino alcohols, and enolic active hydrogen compounds.

Among them, Component F is preferably an acid or a basic compound, more preferably a basic compound, and particularly preferably 1,8-diazabicyclo[5.4.0]undec-7-ene (DBU).

With regard to Component F in the resin composition of the present invention, one type may be used on its own or two or more types may be used in combination.

The content of component F in the resin composition of the present invention is preferably 0.01 to 20 wt % relative to the total weight of Component D, and more preferably 0.1 to 10 wt %.

### <(Component G) Photothermal Conversion Agent>

The resin composition for laser engraving of the present invention preferably further includes a photothermal conversion agent. That is, it is considered that the photothermal conversion agent in the present invention can promote the thermal decomposition of a cured material during laser engraving by absorbing laser light and generating heat. Therefore, it is preferable that a photothermal conversion agent capable of absorbing light having a wavelength of laser used for graving be selected.

When a laser (a YAG laser, a semiconductor laser, a fiber laser, a surface emitting laser, etc.) emitting infrared at a wavelength of 700 to 1,300 nm is used as a light source for laser engraving, it is preferable for the relief printing plate precursor for laser engraving which is produced by using the resin composition for laser engraving of the present invention to comprise a photothermal conversion agent that has a maximum absorption wavelength at 700 to 1,300 nm.

As the photothermal conversion agent in the present invention, various types of dye or pigment are used.

With regard to the photothermal conversion agent, examples of dyes that can be used include commercial dyes and known dyes described in publications such as ‘Senryo Binran’ (Dye Handbook) (Ed. by The Society of Synthetic Organic Chemistry, Japan, 1970). Specific examples include dyes having a maximum absorption wavelength at 700 to 1,300 nm, and preferable examples include azo dyes, metal complex salt azo dyes, pyrazolone azo dyes, naphthoquinone dyes, anthraquinone dyes, phthalocyanine dyes, carbonium dyes, diimmonium compounds, quinone imine dyes, methine dyes, cyanine dyes, squarylium colorants, pyrylium salts, and metal thiolate complexes. In particular, cyanine-based colorants such as heptamethine cyanine colorants, oxonol-based colorants such as pentamethine oxonol colorants, and phthalocyanine-based colorants are preferably used. Examples include dyes described in paragraphs 0124 to 0137 of JP-A-2008-63554.

With regard to the photothermal conversion agent used in the present invention, examples of pigments include commercial pigments and pigments described in the Color Index (C.I.) Handbook, ‘Saishin Ganryo Binran’ (Latest Pigments Handbook) (Ed. by Nippon Ganryo Gijutsu Kyokai, 1977), ‘Saishin Ganryo Ouyogijutsu’ (Latest Applications of Pigment Technology) (CMC Publishing, 1986), ‘Insatsu Inki Gijutsu’ (Printing Ink Technology) (CMC Publishing, 1984). Examples of pigments include pigments described in paragraphs 0122 to 0125 of JP-A-2009-178869.

Among these pigments, carbon black is preferable. Any carbon black, regardless of classification by ASTM (American Society for Testing and Materials) and application (e.g. for coloring, for rubber, for dry cell, etc.), may be used as long as dispersibility, etc. in the resin composition for laser engraving is stable. Examples of the carbon black include furnace black, thermal black, channel black, lamp black, and acetylene black. In order to make dispersion easy, a black colorant such as carbon black may be used as color chips or a color paste by dispersing it in nitrocellulose or a binder in advance using, as necessary, a dispersant, and such chips and paste are readily available as commercial products. Examples of carbon black include carbon blacks described in paragraphs 0130 to 0134 of JP-A-2009-178869.

Component G in the resin composition of the present invention may be used singly or in a combination of two or more compounds.

The content of the photothermal conversion agent in the resin composition for laser engraving of the present invention may vary greatly with the magnitude of the molecular extinction coefficient inherent to the molecule, but the content is preferably 0.01 to 30 wt %, more preferably 0.05 to 20 wt %, and particularly preferably 0.1 to 10 wt %, relative to the total weight of the resin composition.

### <(Component H) Plasticizer>

The resin composition for laser engraving of the present invention may comprise a plasticizer.

A plasticizer has the function of softening a film formed from the resin composition for laser engraving, and it is necessary for it to be compatible with a binder polymer.

Preferred examples of the plasticizer include dioctyl phthalate, didodecyl phthalate, bisbutoxyethyl adipate, a polyethylene glycol, and a polypropylene glycol (monool type or diol type).

Among them, bisbutoxyethyl adipate is particularly preferable.

With regard to Component E in the resin composition of the present invention, one type thereof may be used on its own or two or more types may be used in combination.

From the viewpoint of maintaining flexible film physical properties, the content of the plasticizer in the resin composition for laser engraving of the present invention is preferably 1 to 50 wt % of the entire solids content concentration, more preferably 5 to 40 wt %, and particularly preferably 10 to 30 wt %.

### <(Component I) Solvent>

It is preferably to use (Component I) a solvent when preparing the resin composition for laser engraving of the present invention.

As the solvent, an organic solvent is preferably used.

Specific preferred examples of the aprotic organic solvent include acetonitrile, tetrahydrofuran, dioxane, toluene, propylene glycol monomethyl ether acetate, methyl ethyl ketone, acetone, methyl isobutyl ketone, ethyl acetate, butyl acetate, ethyl lactate, N,N-dimethylacetamide, N-methylpyrrolidone, and dimethyl sulfoxide.

Specific preferred examples of the protic organic solvent include methanol, ethanol, 1-propanol, 2-propanol, 1-butanol, 1-methoxy-2-propanol, ethylene glycol, diethylene glycol, and 1,3-propanediol.

Among these, propylene glycol monomethyl ether acetate is preferable.

### <Other Additives>

The resin composition for laser engraving of the present invention may comprise as appropriate various types of known additives as long as the effects of the present invention are not inhibited. Examples include a filler, a wax, a process oil, an a metal oxide, an antiozonant, an anti-aging agent, a thermopolymerization inhibitor, and a colorant, and one type thereof may be used on its own or two more types may be used in combination.

Furthermore, as another component, a compound that does not have a radical transfer group and has only one hydrolyzable silyl group and/or silanol group may be used.

Specific examples of the compound that does not have a radical transfer group and has only one hydrolyzable silyl group and/or silanol group include vinyltrichlorosilane, vinyltrimethoxysilane, vinyltriethoxysilane, β-(3,4-epoxycyclohexyl)ethyltrimethoxysilane, γ-glycidoxypropyltrimethoxysilane, γ-glycidoxypropylmethyldiethoxysilane, γ-glycidoxypropyltriethoxysilane, γ-methacryloxypropylmethyldimethoxysilane, p-styryltrimethoxysilane, γ-methacryloxypropyltrimethoxysilane, γ-methacryloxypropylmethyldiethoxysilane, γ-methacryloxypropyltriethoxysilane, γ-acryloxypropyltrimethoxysilane, N-(β-aminoethyl)-γ-aminopropyl methyldi methoxysilane, N-(β-aminoethyl)-γ-aminopropyltrimethoxysilane, N-(β-aminoethyl)-γ-aminopropyltriethoxysilane, γ-aminopropyltrimethoxysilane, γ-aminopropyltriethoxysilane, N-phenyl-γ-aminopropyltrimethoxysilane, γ-mercaptopropyltrimethoxysilane, γ-mercaptopropyltriethoxysilane, mercaptomethyltrimethoxysilane, dimethoxy-3-mercaptopropylmethylsilane, 2-(2-aminoethylthioethyl)diethoxymethylsilane, 3-(2-acetoxyethylthiopropyl)dimethoxymethylsilane, 2-(2-aminoethylthioethyl)triethoxysilane, dimethoxymethyl-3-(3-phenoxypropylthiopropyl)silane, bis(triethoxysilylpropyl)disulfide, bis(triethoxysilylpropyl)tetrasulfide, 1,4-bis(triethoxysilyl)benzene, bis(triethoxysilyl)ethane, 1,6-bis(trimethoxysilyl)hexane, 1,8-bis(triethoxysilyl)octane, 1,2-bis(trimethoxysilyl)decane, bis(triethoxysilylpropyl)amine, bis(trimethoxysilylpropyl)urea, γ-chloropropyltrimethoxysilane, γ-ureidopropyltriethoxysilane, trimethylsilanol, diphenylsilanediol, triphenylsilanol, methyltrimethoxysilane, methyltriethoxysilane, phenyltrimethoxysilane, phenyltriethoxysilane, dimethyldimethoxysilane, dimethyldiethoxysilane, diphenyldimethoxysilane, and diphenyldiethoxysilane, etc.

### (Relief Printing Plate Precursor for Laser Engraving)

A first embodiment of the relief printing plate precursor for laser engraving of the present invention comprises a relief-forming layer formed from the resin composition for laser engraving of the present invention.

A second embodiment of the relief printing plate precursor for laser engraving of the present invention comprises a crosslinked relief-forming layer formed by crosslinking a relief-forming layer formed from the resin composition for laser engraving of the present invention.

In the present invention, the ‘relief printing plate precursor for laser engraving’ means both or one of a flexographic printing plate precursor having a crosslinkable relief-forming layer formed from the resin composition for laser engraving in a state before being crosslinked and a relief printing plate precursor in a state in which it is cured by light or heat.

The relief printing plate precursor for laser engraving of the present invention is a relief printing plate precursor having a crosslinkable relief-forming layer cured by heat.

In the present invention, the ‘relief-forming layer’ means a layer in a state before being crosslinked, that is, a layer formed from the resin composition for laser engraving of the present invention, which may be dried as necessary.

In the present invention, the “crosslinked relief-forming layer” refers to a layer obtained by crosslinking the aforementioned relief-forming layer. The crosslinking can be performed by light and/or heat, and the crosslinking by heat is preferable. Moreover, the crosslinking is not particularly limited only if it is a reaction that cures the resin composition, and is a general idea that includes the crosslinked structure by the reaction of Component A with each other, and the reaction of Component A with other Component. When a polymerizable compound is used, the crosslinking includes a crosslinking by polymerization of polymerizable compounds.

The ‘relief printing plate’ is made by laser engraving the relief printing plate precursor having the crosslinked relief-forming layer.

Moreover, in the present invention, the ‘relief layer’ means a layer of the relief printing plate formed by engraving using a laser, that is, the crosslinked relief-forming layer after laser engraving.

A relief printing plate precursor for laser engraving of the present invention comprises a relief-forming layer formed from the resin composition for laser engraving of the present invention, which has the above-mentioned components. The (crosslinked) relief-forming layer is preferably provided above a support.

The (crosslinked) relief printing plate precursor for laser engraving may further comprise, as necessary, an adhesive layer between the support and the (crosslinked) relief-forming layer and, above the relief-forming layer, a slip coat layer and a protection film.

### <Relief-Forming Layer>

The relief-forming layer is a layer formed from the resin composition for laser engraving of the present invention, and is preferably crosslinkable by heat.

As a mode in which a relief printing plate is prepared using the relief printing plate precursor for laser engraving, a mode in which a relief printing plate is prepared by crosslinking a relief-forming layer to thus form a relief printing plate precursor having a crosslinked relief-forming layer, and the crosslinked relief-forming layer (hard relief-forming layer) is then laser-engraved to thus form a relief layer is preferable. By crosslinking the relief-forming layer, it is possible to prevent abrasion of the relief layer during printing, and it is possible to obtain a relief printing plate having a relief layer with a sharp shape after laser engraving.

The relief-forming layer may be formed by molding the resin composition for laser engraving that has the above-mentioned components for a relief-forming layer into a sheet shape or a sleeve shape. The relief-forming layer is usually provided above a support, which is described later, but it may be formed directly on the surface of a member such as a cylinder of equipment for plate producing or printing or may be placed and immobilized thereon, and a support is not always required.

A case in which the relief-forming layer is mainly formed in a sheet shape is explained as an example below.

### <Support>

A material used for the support of the relief printing plate precursor for laser engraving is not particularly limited, but one having high dimensional stability is preferably used, and examples thereof include metals such as steel, stainless steel, or aluminum, plastic resins such as a polyester (e.g. polyethylene terephthalate (PET), polybutylene terephthalate (PBT), or polyacrylonitrile (PAN)) or polyvinyl chloride, synthetic rubbers such as styrene-butadiene rubber, and glass fiber-reinforced plastic resins (epoxy resin, phenolic resin, etc.). As the support, a PET film or a steel substrate is preferably used. The configuration of the support depends on whether the relief-forming layer is in a sheet shape or a sleeve shape.

<Adhesive layer>

An adhesive layer may be provided between the relief-forming layer and the support for the purpose of strengthening the adhesion between the two layers. Examples of materials (adhesives) that can be used in the adhesive layer include those described in ‘Handbook of Adhesives’, Second Edition, Ed by I. Skeist, (1977).

### <Protection Film, Slip Coat Layer>

For the purpose of preventing scratches or dents in the relief-forming layer surface or the crosslinked relief-forming layer surface, a protection film may be provided on the relief-forming layer surface or the crosslinked relief-forming layer surface. The thickness of the protection film is preferably 25 to 500 μm, and more preferably 50 to 200 μm. The protection film may employ, for example, a polyester-based film such as PET or a polyolefin-based film such as PE (polyethylene) or PP (polypropylene). The surface of the film may be made matte. The protection film is preferably peelable.

When the protection film is not peelable or conversely has poor adhesion to the relief-forming layer, a slip coat layer may be provided between the two layers. The material used in the slip coat layer preferably employs as a main component a resin that is soluble or dispersible in water and has little tackiness, such as polyvinyl alcohol, polyvinyl acetate, partially saponified polyvinyl alcohol, a hydroxyalkylcellulose, an alkylcellulose, or a polyamide resin.

### (Process for Producing Relief Printing Plate Precursor for Laser Engraving)

The process for producing a relief printing plate precursor for laser engraving is not particularly limited, and examples thereof include a method in which a resin composition for laser engraving is prepared, solvent is removed from this coating solution composition for laser engraving, and it is then melt-extruded onto a support. Alternatively, a method may be employed in which a resin composition for laser engraving is cast onto a support, and this is dried in an oven to thus remove solvent from the resin composition.

Among them, the process for producing a relief printing plate precursor for laser engraving of the present invention is preferably a production process comprising a layer formation step of forming a relief-forming layer from the resin composition for laser engraving of the present invention and a crosslinking step of crosslinking the relief-forming layer by means of heat and/or light to thus obtain a relief printing plate precursor having a crosslinked relief-forming layer, and more preferably a production process comprising a layer formation step of forming a relief-forming layer from the resin composition for laser engraving of the present invention and a crosslinking step of crosslinking the relief-forming layer by means of heat to thus obtain a relief printing plate precursor having a crosslinked relief-forming layer.

Subsequently, as necessary, a protection film may be laminated on the relief-forming layer. Laminating may be carried out by compression-bonding the protection film and the relief-forming layer by means of heated calendar rollers, etc. or putting a protection film into intimate contact with a relief-forming layer whose surface is impregnated with a small amount of solvent.

When a protection film is used, a method in which a relief-forming layer is first layered on a protection film and a support is then laminated may be employed.

When an adhesive layer is provided, it may be dealt with by use of a support coated with an adhesive layer. When a slip coat layer is provided, it may be dealt with by use of a protection film coated with a slip coat layer.

### <Layer Formation Step>

The process for producing the relief printing plate precursor for laser engraving of the present invention preferably comprises a layer formation step of forming a relief-forming layer from the resin composition for laser engraving of the present invention.

Preferred examples of a method for forming the relief-forming layer include a method in which the resin composition for laser engraving of the present invention is prepared, solvent is removed as necessary from this resin composition for laser engraving, and it is then melt-extruded onto a support and a method in which the resin composition for laser engraving of the present invention is prepared, the resin composition for laser engraving of the present invention is cast onto a support, and this is dried in an oven to thus remove solvent.

The resin composition for laser engraving may be produced by, for example, dissolving Components A, B, and D, and as optional components, Components F to H an appropriate solvent, and then dissolving Components C and E. It is necessary to remove most of the solvent component in a stage of producing a relief printing plate precursor. It is preferable to use as the solvent a volatile one such as low molecular weight alcohol (for example, methanol, ethanol, n-propanol, isopropanol, propylene glycol monomethylether) and adjust the temperature, etc. to thus reduce as much as possible the total amount of solvent to be added.

The thickness of the (crosslinked) relief-forming layer in the relief printing plate precursor for laser engraving is preferably 0.05 to 10 mm before and after crosslinking, more preferably 0.05 to 7 mm, and yet more preferably 0.05 to 3 mm.

### <Crosslinking Step>

The process for producing a relief printing plate precursor for laser engraving of the present invention is preferably a production process comprising a crosslinking step of crosslinking the relief-forming layer by means of light and/or heat to thus obtain a relief printing plate precursor having a crosslinked relief-forming layer.

When the relief-forming layer comprises a photopolymerization initiator, the relief-forming layer may be crosslinked by irradiating the relief-forming layer with actinic radiation that triggers the photopolymerization initiator.

It is preferable to apply light to the entire surface of the relief-forming layer. Examples of the light (also called ‘actinic radiation’) include visible light, UV light, and an electron beam, but UV light is most preferably used. When the side where there is a substrate, such as a relief-forming layer support, for fixing the relief-forming layer, is defined as the reverse face, only the front face need be irradiated with light, but when the support is a transparent film through which actinic radiation passes, it is preferable to further irradiate the reverse face with light as well. When a protection film is present, irradiation from the front face may be carried out with the protection film as it is or after peeling off the protection film. Since there is a possibility of polymerization being inhibited in the presence of oxygen, irradiation with actinic radiation may be carried out after superimposing a polyvinyl chloride sheet on the relief-forming layer and evacuating.

When the relief-forming layer comprises a thermopolymerization initiator (it being possible for the above-mentioned photopolymerization initiator to function also as a thermopolymerization initiator), the relief-forming layer may be crosslinked by heating the relief printing plate precursor for laser engraving (step of crosslinking by means of heat). As heating means, there can be cited a method in which a printing plate precursor is heated in a hot air oven or a far-infrared oven for a predetermined period of time and a method in which it is put into contact with a heated roller for a predetermined period of time.

As a method for crosslinking the relief-forming layer, from the viewpoint of the relief-forming layer being uniformly curable (crosslinkable) from the surface into the interior, crosslinking by heat is preferable.

Due to the relief-forming layer being crosslinked, firstly, a relief formed after laser engraving becomes sharp and, secondly, tackiness of engraving residue formed when laser engraving is suppressed. If an uncrosslinked relief-forming layer is laser-engraved, residual heat transmitted to an area around a laser-irradiated part easily causes melting or deformation of a part that is not targeted, and a sharp relief layer cannot be obtained in some cases. Furthermore, in terms of the general properties of a material, the lower the molecular weight, the more easily it becomes a liquid rather than a solid, that is, there is a tendency for tackiness to be stronger. Engraving residue formed when engraving a relief-forming layer tends to have higher tackiness the more that low-molecular-weight materials are used. Since a polymerizable compound, which is a low-molecular-weight material, becomes a polymer by crosslinking, the tackiness of the engraving residue formed tends to decrease.

When the crosslinking step is a step of carrying out crosslinking by light, although equipment for applying actinic radiation is relatively expensive, since a printing plate precursor does not reach a high temperature, there are hardly any restrictions on starting materials for the printing plate precursor.

When the crosslinking step is a step of carrying out crosslinking by heat, although there is the advantage that particularly expensive equipment is not needed, since a printing plate precursor reaches a high temperature, it is necessary to carefully select the starting materials used while taking into consideration the possibility that a thermoplastic polymer, which becomes soft at high temperature, will deform during heating, etc.

During thermal crosslinking, it is preferable to add a thermopolymerization initiator. As the thermopolymerization initiator, a commercial thermopolymerization initiator for free radical polymerization may be used. Examples of such a thermopolymerization initiator include an appropriate peroxide, hydroperoxide, and azo group-containing compound. A representative vulcanizing agent may also be used for crosslinking. Thermal crosslinking may also be carried out by adding a heat-curable resin such as for example an epoxy resin as a crosslinking component to a layer.

### (Relief Printing Plate and Process for Making Same)

The process for making a relief printing plate of the present invention preferably comprises a layer formation step of forming a relief-forming layer from the resin composition for laser engraving of the present invention, a crosslinking step of crosslinking the relief-forming layer by means of heat and/or light to thus obtain a relief printing starting plate having a crosslinked relief-forming layer, and an engraving step of laser-engraving the relief printing starting plate having the crosslinked relief-forming layer, and more preferably comprises a layer formation step of forming a relief-forming layer from the resin composition for laser engraving of the present invention, a crosslinking step of crosslinking the relief-forming layer by means of heat to thus obtain a relief printing starting plate having a crosslinked relief-forming layer, and an engraving step of laser-engraving the relief printing starting plate having the crosslinked relief-forming layer

The relief printing plate of the present invention is a relief printing plate having a relief layer obtained by crosslinking and laser-engraving a layer formed from the resin composition for laser engraving of the present invention, and is preferably a relief printing plate made by the process for making a relief printing plate of the present invention.

The layer formation step and the crosslinking step in the process for making a relief printing plate of the present invention mean the same as the layer formation step and the crosslinking step in the above-mentioned process for producing a relief printing starting plate for laser engraving, and preferred ranges are also the same.

### <Engraving Step>

The process for producing a relief printing plate of the present invention preferably comprises an engraving step of laser-engraving the relief printing plate precursor having a crosslinked relief-forming layer.

The engraving step is a step of laser-engraving a crosslinked relief-forming layer that has been crosslinked in the crosslinking step to thus form a relief layer. Specifically, it is preferable to engrave a crosslinked relief-forming layer that has been crosslinked by irradiation with laser light according to a desired image, thus forming a relief layer. Furthermore, a step in which a crosslinked relief-forming layer is subjected to scanning irradiation by controlling a laser head using a computer in accordance with digital data of a desired image can preferably be cited.

This engraving step preferably employs an infrared laser. When irradiated with an infrared laser, molecules in the crosslinked relief-forming layer undergo molecular vibration, thus generating heat. When a high power laser such as a carbon dioxide laser or a YAG laser is used as the infrared laser, a large quantity of heat is generated in the laser-irradiated area, and molecules in the crosslinked relief-forming layer undergo molecular scission or ionization, thus being selectively removed, that is, engraved. The advantage of laser engraving is that, since the depth of engraving can be set freely, it is possible to control the structure three-dimensionally. For example, for an area where fine halftone dots are printed, carrying out engraving shallowly or with a shoulder prevents the relief from collapsing due to printing pressure, and for a groove area where a fine outline character is printed, carrying out engraving deeply makes it difficult for ink the groove to be blocked with ink, thus enabling breakup of an outline character to be suppressed.

In particular, when engraving is carried out using an infrared laser that corresponds to the absorption wavelength of the photothermal conversion agent, it becomes possible to selectively remove the crosslinked relief-forming layer at higher sensitivity, thus giving a relief layer having a sharp image.

As the infrared laser used in the engraving step, from the viewpoint of productivity, cost, etc., a carbon dioxide laser (a CO₂ laser) or a semiconductor laser is preferable. In particular, a fiber-coupled semiconductor infrared laser (FC-LD) is preferably used. In general, compared with a CO₂ laser, a semiconductor laser has higher efficiency laser oscillation, is less expensive, and can be made smaller. Furthermore, it is easy to form an array due to the small size. Moreover, the shape of the beam can be controlled by treatment of the fiber.

With regard to the semiconductor laser, one having a wavelength of 700 to 1,300 nm is preferable, one having a wavelength of 800 to 1,200 nm is more preferable, one having a wavelength of 860 to 1,200 nm is yet more preferable, and one having a wavelength of 900 to 1,100 nm is particularly preferable.

Furthermore, the fiber-coupled semiconductor laser can output laser light efficiently by being equipped with optical fiber, and this is effective in the engraving step in the present invention. Moreover, the shape of the beam can be controlled by treatment of the fiber. For example, the beam profile may be a top hat shape, and energy can be applied stably to the plate face. Details of semiconductor lasers are described in ‘Laser Handbook 2^{nd} Edition’ The Laser Society of Japan, Applied Laser Technology, The Institute of Electronics and Communication Engineers, etc.

Moreover, as plate producing equipment comprising a fiber-coupled semiconductor laser that can be used suitably in the process for producing a relief printing plate employing the relief printing plate precursor of the present invention, those described in detail in JP-A-2009-172658 and JP-A-2009-214334 can be cited. Such equipment comprising a fiber-coupled semiconductor laser can be used to produce a relief printing plate of the present invention.

The process for producing a relief printing plate of the present invention may as necessary further comprise, subsequent to the engraving step, a rinsing step, a drying step, and/or a post-crosslinking step, which are shown below.

Rinsing step: a step of rinsing the engraved surface by rinsing the engraved relief layer surface with water or a liquid comprising water as a main component.

Drying step: a step of drying the engraved relief layer.

Post-crosslinking step: a step of further crosslinking the relief layer by applying energy to the engraved relief layer.

After the above-mentioned step, since engraving residue is attached to the engraved surface, a rinsing step of washing off engraving residue by rinsing the engraved surface with water or a liquid comprising water as a main component may be added. Examples of rinsing means include a method in which washing is carried out with tap water, a method in which high pressure water is spray-jetted, and a method in which the engraved surface is brushed in the presence of mainly water using a batch or conveyor brush type washout machine known as a photosensitive resin letterpress plate processor, and when slime due to engraving residue cannot be eliminated, a rinsing liquid to which a soap or a surfactant is added may be used.

When the rinsing step of rinsing the engraved surface is carried out, it is preferable to add a drying step of drying an engraved relief-forming layer so as to evaporate rinsing liquid.

Furthermore, as necessary, a post-crosslinking step for further crosslinking the relief-forming layer may be added. By carrying out a post-crosslinking step, which is an additional crosslinking step, it is possible to further strengthen the relief formed by engraving.

The pH of the rinsing liquid that can be used in the present invention is preferably at least 9, more preferably at least 10, and yet more preferably at least 11. The pH of the rinsing liquid is preferably no greater than 14, more preferably no greater than 13.5, and yet more preferably no greater than 13.1. When in the above-mentioned range, handling is easy.

In order to set the pH of the rinsing liquid in the above-mentioned range, the pH may be adjusted using an acid and/or a base as appropriate, and the acid or base used is not particularly limited.

The rinsing liquid that can be used in the present invention preferably comprises water as a main component.

The rinsing liquid may contain as a solvent other than water a water-miscible solvent such as an alcohol, acetone, or tetrahydrofuran.

The rinsing liquid preferably comprises a surfactant.

From the viewpoint of removability of engraving residue and little influence on a relief printing plate, preferred examples of the surfactant that can be used in the present invention include betaine compounds (amphoteric surfactants) such as a carboxybetaine compound, a sulfobetaine compound, a phosphobetaine compound, an amine oxide compound, and a phosphine oxide compound.

Furthermore, examples of the surfactant also include known anionic surfactants, cationic surfactants, and nonionic surfactants. Moreover, a fluorine-based or silicone-based nonionic surfactant may also be used in the same manner.

With regard to the surfactant, one type may be used on its own or two or more types may be used in combination.

It is not necessary to particularly limit the amount of surfactant used, but it is preferably 0.01 to 20 wt % relative to the total weight of the rinsing liquid, and more preferably 0.05 to 10 wt %.

The relief printing plate of the present invention having a relief layer may be produced as described above.

From the viewpoint of satisfying suitability for various aspects of flexographic printing, such as abrasion resistance and ink transfer properties, the thickness of the relief layer of the relief printing plate is preferably at least 0.05 mm but no greater than 10 mm, more preferably at least 0.05 mm but no greater than 7 mm, and particularly preferably at least 0.05 mm but no greater than 3 mm.

Furthermore, the Shore A hardness of the relief layer of the relief printing plate is preferably at least 50° but no greater than 90°. When the Shore A hardness of the relief layer is at least 50°, even if fine halftone dots formed by engraving receive a strong printing pressure from a letterpress printer, they do not collapse and close up, and normal printing can be carried out. Furthermore, when the Shore A hardness of the relief layer is no greater than 90°, even for flexographic printing with kiss touch printing pressure it is possible to prevent patchy printing in a solid printed part.

The Shore A hardness in the present specification is a value measured by a durometer (a spring type rubber hardness meter) that presses an indenter (called a pressing needle or indenter) into the surface of a measurement target at 25° C. so as to deform it, measures the amount of deformation (indentation depth), and converts it into a numerical value.

The relief printing plate of the present invention is particularly suitable for printing with an aqueous ink by a flexographic printing machine; however, the relief printing plate is capable of printing even when any of an aqueous ink, an oil-based ink and a UV ink is used with a letterpress printing machine, and printing with a UV ink by a flexographic printing machine is also possible. The relief printing plate of the present invention has no or less bending (curling) in the printing plate as a whole, has excellent rinsing properties, there is no engraved residue, and has excellent printing durability, and printing can be carried out for a long period of time without plastic deformation of the relief layer or degradation of printing durability.

In accordance with the present invention, there can be provided a resin composition for laser engraving that can give a film having excellent compositional uniformity and toughness and a relief printing plate having little breakage of small-size halftone dots, a relief printing plate precursor employing the resin composition for laser engraving, a process for making a relief printing plate employing same, and a relief printing plate obtained thereby.

### EXAMPLES

Hereinafter, the present invention will be more specifically described by way of Examples, but the present invention is not intended to be limited to these Examples.

### Example 1

### Preparation of Relief Printing Plate Precursor for Laser Engraving

(Component A) the compound shown in Table 1, (Component B) the radically polymerizable compound, (Component D) the resin, and the materials shown below were mixed. The solids content concentrations of Component A, Component B, and Component D are shown in Table 1. Materials other than Component A, Component B, and Component D were mixed at the proportions below.

(Component A) compound shown in Table 1: parts by weight shown in Table 1
(Component B) radically polymerizable compound: parts by weight shown in Table 1
(Component D) resin: parts by weight shown in Table 1
Bisbutoxyethyl adipate: 25 parts by weight
Carbon black: 4 parts by weight
DBU (condensation reaction catalyst): 1 part by weight
Propylene glycol monomethyl ether acetate (solvent): 20 parts by weight

A three-necked flask equipped with a stirring blade and a condenser was charged with the components above, and they were dissolved by heating at 70° C. while stirring for 120 minutes. After the temperature of this solution was set at 40° C., Component E and Component C below were added thereto, and stirring was carried out for a further 10 minutes, thus preparing a flowable resin composition. The solids content concentration of Component E is shown in Table 1.

(Component E) alkoxysilane compound: parts by weight shown in Table 1
Perbutyl Z (Component C, NOF Corporation): 1 part by weight

A 3 mm thick spacer (frame) was placed on a PET substrate, and the resin composition so obtained was maintained at 70° C. and cast gently so that it did not flow out of the spacer (frame). The coated sample was placed in an oven and heated at 90° C. for 1 hour then at 85° C. for a further 3 hours, thus giving a relief printing plate precursor for laser engraving having a crosslinked relief layer.

### <Electron Probe Microanalyzer (EPMA) Cross-Section Measurement (Film Internal Compositional Uniformity Evaluation)>

The relief printing plate precursor for laser engraving so obtained was embedded in an epoxy resin, the plate cross-section was exposed by a microtome, and EPMA mapping of silicon was carried out using a JXA-8800M (JEOL) at a resolution of 10 μm. The coefficient of variation (standard deviation/average value) of the silicon signal intensity within the plate cross-section so obtained was used as an indicator for uniformity. The smaller the coefficient of variation, the better the uniformity of the film internal composition.

The evaluation results are shown in Table 1.

### <Evaluation of Elongation at Break (Toughness Evaluation)>

The crosslinked relief layer was peeled off from the relief printing plate precursor for laser engraving so obtained, and the peeled-off crosslinked relief layer was cut into a sample piece having a width of 6 mm and an initial sample length of 20 mm. The sample piece was pulled using a digital force gauge (Nidec-Shimpo Corporation, FGP-5) at a rate of 5 mm/min, and sample elongation and input force were measured. The thickness was measured separately. The input stress (MPa) and elongation at break (%) when the sample broke were determined, and the elastic modulus was calculated from input stress/elongation at break×100. This measurement was carried out in accordance with JIS K6251. The evaluation results are shown in Table 1.

### <Evaluation of Frequency of Occurrence of Small Dot Breakage>

With regard to the crosslinked relief-forming layer of a printing plate precursor for laser engraving, a 1 cm square 2×2 dot halftone area was raster-engraved using a carbon dioxide laser (CO₂ laser) engraving machine under conditions of an output of 12 W, a head speed of 200 mm/sec, and a pitch setting of 2,400 DPI.

The carbon dioxide laser engraving machine employed was an ML-9100 series high quality CO₂ laser marker (Keyence).

Printing was carried out for the 1 cm square 2×2 dot halftone area with the standard printing pressure repeatedly 100 times, halftone dot images from the first time and the 100^{th} time were compared, the number of halftone dots that had disappeared was counted, the proportion relative to the total number of halftone dots was determined, and this was defined as the frequency of occurrence of small dot breakage. It was confirmed by examination, using an optical microscope, of a relief halftone dot corresponding to a halftone image dot that had disappeared that the halftone dot was damaged.

A frequency of occurrence of small dot breakage of less than 0.1% was evaluated as excellent, at least 0.1% but less than 0.5% as good, at least 0.5% but less than 2.0% as fair, and 2.0% or greater as poor.

The evaluation results are shown in Table 1.

### Examples 2 to 30 and Comparative Examples 1 and 2

Resin compositions for laser engraving and relief printing plate precursors for laser engraving of Examples 2 to 30 and Comparative Examples 1 and 2 were obtained in the same manner as in Example 1 except that Component A, Component B, Component D, and Component E were changed to the components and amounts added shown in Table 1.

The relief printing plate precursors for laser engraving obtained were subjected to evaluation of film internal compositional uniformity, evaluation of elongation at break, and evaluation of frequency of occurrence of small dot breakage by the same methods as in Example 1.

The evaluation results are shown in Table 1.

TABLE 1

| | Component A | | Component B | | Component D | | Component E | | | | | |
|---|---|---|---|---|---|---|---|---|---|---|---|---|
| | | Amount | | Amount | | Amount | | Amount | EPMA | Elongn. | | Small dot |
| | | added | | added | | added | | added | Si Var. | at break | Elastic | breakage |
| | Type | (pbw) | Type | (pbw) | Type | (pbw) | Type | (pbw) | Coeff. | (%) | modulus | frequency |
| Ex. 1 | A-1 | 0.3 | DPHA | 15 | PVB | 29.7 | S-1 | 18 | 9.1 | 81 | 2.5 | Exc. |
| Ex. 2 | A-1 | 0.8 | DPHA | 15 | PVB | 29.2 | S-1 | 18 | 7.5 | 94 | 2.4 | Exc. |
| Ex. 3 | A-1 | 1.2 | DPHA | 15 | PVB | 28.8 | S-1 | 18 | 4.8 | 101 | 2.1 | Exc. |
| Ex. 4 | A-1 | 2 | DPHA | 15 | PVB | 28 | S-1 | 18 | 3.5 | 110 | 2.1 | Exc. |
| Ex. 5 | A-1 | 4 | DPHA | 15 | PVB | 26 | S-1 | 18 | 3.2 | 107 | 2.2 | Exc. |
| Ex. 6 | A-1 | 8 | DPHA | 15 | PVB | 22 | S-1 | 18 | 4.6 | 99 | 2.0 | Exc. |
| Ex. 7 | A-1 | 16 | DPHA | 15 | PVB | 14 | S-1 | 18 | 6.1 | 80 | 1.8 | Exc. |
| Ex. 8 | A-1 | 2 | DPHA | 5 | PVB | 40 | S-1 | 18 | 5.2 | 64 | 1.6 | Exc. |
| Ex. 9 | A-1 | 2 | DPHA | 10 | PVB | 35 | S-1 | 18 | 4.1 | 86 | 1.9 | Exc. |
| Ex. 10 | A-1 | 2 | DPHA | 20 | PVB | 25 | S-1 | 18 | 3.9 | 73 | 2.5 | Exc. |
| Ex. 11 | A-1 | 2 | DPHA | 30 | PVB | 15 | S-1 | 18 | 5.9 | 65 | 2.8 | Exc. |
| Ex. 12 | A-1 | 2 | DPHA | 15 | PVB | 44 | S-1 | 4 | 3.9 | 51 | 2.4 | Exc. |
| Ex. 13 | A-1 | 2 | DPHA | 15 | PVB | 40 | S-1 | 8 | 3.7 | 60 | 2.3 | Exc. |
| Ex. 14 | A-1 | 2 | DPHA | 15 | PVB | 34 | S-1 | 14 | 3.4 | 89 | 2.2 | Exc. |
| Ex. 15 | A-1 | 2 | DPHA | 15 | PVB | 24 | S-1 | 24 | 5.3 | 108 | 2.0 | Exc. |
| Ex. 16 | A-1 | 2 | DPHA | 15 | PVB | 18 | S-1 | 30 | 6.8 | 110 | 1.8 | Exc. |
| Ex. 17 | A-2 | 2 | DPHA | 15 | PVB | 28 | S-1 | 18 | 3.7 | 118 | 2.2 | Exc. |
| Ex. 18 | A-3 | 2 | DPHA | 15 | PVB | 28 | S-1 | 18 | 3.1 | 120 | 2.3 | Exc. |
| Ex. 19 | A-4 | 2 | DPHA | 15 | PVB | 28 | S-1 | 18 | 5.2 | 104 | 2.1 | Exc. |
| Ex. 20 | A-5 | 2 | DPHA | 15 | PVB | 28 | S-1 | 18 | 7.6 | 87 | 2.1 | Exc. |
| Ex. 21 | A-6 | 2 | DPHA | 15 | PVB | 28 | S-1 | 18 | 8.2 | 85 | 2.2 | Exc. |
| Ex. 22 | A-3 | 2 | DCP | 15 | PVB | 28 | S-1 | 18 | 6.7 | 95 | 2.3 | Exc. |
| Ex. 23 | A-3 | 2 | TMMT | 15 | PVB | 28 | S-1 | 18 | 5.3 | 102 | 2.2 | Exc. |
| Ex. 24 | A-3 | 2 | DPHA | 15 | PVB | 28 | S-7 | 18 | 3.8 | 96 | 2.1 | Exc. |
| Ex. 25 | A-3 | 2 | DPHA | 15 | PVB | 28 | S-5 | 18 | 3.0 | 115 | 2.3 | Exc. |
| Ex. 26 | A-3 | 2 | DPHA | 15 | PVB | 28 | S-8 | 18 | 4.6 | 94 | 2.2 | Exc. |
| Ex. 27 | A-3 | 2 | DPHA | 15 | PVB | 28 | S-12 | 18 | 5.2 | 99 | 2.4 | Exc. |
| Ex. 28 | A-3 | 2 | DPHA | 15 | SI | 28 | S-8 | 18 | 8.9 | 57 | 1.7 | Exc. |
| Ex. 29 | A-6 | 2 | DPHA | 15 | SI | 28 | S-8 | 18 | 9.1 | 54 | 1.6 | Exc. |
| Ex. 30 | A-1 | 8 | DPHA | 25 | PVB | 30 | — | — | 5.4 | 52 | 2.4 | Good |
| Comp. | — | — | DPHA | 15 | PVB | 30 | S-1 | 18 | 18.7 | 39 | 2.4 | Poor |
| Ex. 1 | | | | | | | | | | | | |
| Comp. | A-1 | 2 | — | — | PVB | 45 | S-5 | 18 | 4.3 | 103 | 0.5 | Fair |
| Ex. 2 | | | | | | | | | | | | |

The compounds denoted by abbreviated symbols in Table 1 above are as follows.
A-1 to A-6, S-1, S-5, S-7, S-8, and S-12 in Table 1 above are the same as described above.
DPHA: dipentaerythritol hexaacrylate (Daicel-Cytec Company Ltd.)
DCP: tricyclodecanedimethanol dimethacrylate (Shin-Nakamura Chemical Co., Ltd.)
TMMT: pentaerythritol tetraacrylate (Shin-Nakamura Chemical Co., Ltd.)
PVB: polyvinyl butyral (Denka Butyral #3000-2, Denki Kagaku Kogyo Kabushiki Kaisha, Mw = 90,000)
SI: styrene isoprene block polymer (Quintac 3421, Nippon Zeon Corporation)

What is claimed is:

1. A resin composition for laser engraving, comprising:
(Component A) a compound having one or more condensable groups and having one or more radical chain transfer groups;
(Component B) a radically polymerizable compound;
(Component C) a radical polymerization initiator; and
(Component D) a binder polymer.

2. The resin composition for laser engraving according to claim 1, wherein Component D has a group that can react with the condensable group.

3. The resin composition for laser engraving according to claim 1, wherein the condensable group is a hydrolyzable silyl group and/or silanol group.

4. The resin composition for laser engraving according to claim 1, wherein the radical chain transfer group is a thiol group or a disulfide group.

5. The resin composition for laser engraving according to claim 1, wherein the resin composition further comprises (Component E) a compound having two or more hydrolyzable silyl groups and/or silanol groups.

6. The resin composition for laser engraving according to claim 1, wherein the resin composition further comprises (Component F) a condensation reaction catalyst.

7. The resin composition for laser engraving according to claim 1, wherein Component B comprises a compound having two or more (meth)acrylic groups.

8. The resin composition for laser engraving according to claim 3, wherein the resin composition further comprises (Component E) a compound having two or more hydrolyzable silyl groups and/or silanol groups.

9. The resin composition for laser engraving according to claim 3, wherein the resin composition further comprises (Component F) a condensation reaction catalyst.

10. The resin composition for laser engraving according to claim 8, wherein the resin composition further comprises (Component F) a condensation reaction catalyst.

11. A relief printing plate precursor for laser engraving having a relief-forming layer comprising the resin composition for laser engraving according to claim 1.

12. A relief printing plate precursor for laser engraving having a crosslinked relief-forming layer formed by thermally crosslinking a relief-forming layer comprising the resin composition for laser engraving according to claim 1.

13. A process for producing a relief printing plate precursor for laser engraving, comprising:
a layer formation step of forming a relief-forming layer comprising the resin composition for laser engraving according to claim 1; and
a crosslinking step of crosslinking the relief-forming layer by means of light and/or heat to thus obtain a relief printing plate precursor having a crosslinked relief-forming layer.

14. A process for making a relief printing plate, comprising:
a layer formation step of forming a relief-forming layer comprising the resin composition for laser engraving according to claim 1;
a crosslinking step of crosslinking the relief-forming layer by means of light and/or heat to thus obtain a relief printing plate precursor having a crosslinked relief-forming layer; and
an engraving step of laser-engraving the relief printing plate precursor having a crosslinked relief-forming layer to thus form a relief layer.

15. The process for making a relief printing plate according to claim 14, wherein it further comprises a rinsing step of rising the relief layer surface after engraving with an aqueous rinsing liquid.

16. A relief printing plate having a relief layer made by the process for making a relief printing plate according to claim 14.

17. The relief printing plate according to claim 16, wherein the relief layer has a thickness of at least 0.05 mm but no greater than 10 mm.

18. The relief printing plate according to claim 16, wherein the relief layer has a Shore A hardness of at least 50° but no greater than 90°.
